(19) United States
(12) Patent Application Publication
(10) Pub. No.: US 2026/0162391 A1
(43) Pub. Date: Jun. 11, 2026

(54) SERVICE PROCESSING METHODS AND SYSTEMS

(71) Applicant: Tencent Technology (Shenzhen) Company Limited, Shenzhen (CN)

(72) Inventors: Chun Yuan, Shenzhen (CN); Dongkai Zha, Shenzhen (CN)

(21) Appl. No.: 19/179,511

(22) Filed: Apr. 15, 2025

Related U.S. Application Data
(63) Continuation of application No. PCT/CN2024/078223, filed on Feb. 23, 2024.

(30) Foreign Application Priority Data
Apr. 23, 2023 (CN) 202310439600.7

(51) Int. Cl. G06T 19/20; G06T 13/40; G06T 15/08

(52) U.S. Cl. CPC G06T 19/20; G06T 13/40; G06T 15/08; G06T 2219/2004

(57) ABSTRACT

Aspects described herein provide techniques for realistically and efficiently simulating hair. An illustrative method includes obtaining a hair root point cloud of a character; obtaining sampling control information, the sampling control information being configured for controlling a distance between sampling points in a sampling process of the hair root point cloud; sampling the hair root point cloud according to the sampling control information, to obtain sampling points; and determining virtual hairs corresponding to the sampling points as simulated virtual hairs, and determining virtual hairs corresponding to hair root points other than the sampling points in the hair root point cloud as interpolated virtual hairs, dynamic effect simulation being performed on the simulated virtual hairs by using a physical simulation policy in an execution process of the service, and the simulated virtual hairs being configured for controlling the interpolated virtual hairs to move with the simulated virtual hairs in the execution process of the service.

### CROSS REFERENCE TO RELATED APPLICATIONS

This application is a continuation application of PCT Application PCT/CN2024/078223, filed Feb. 23, 2024, which claims priority to Chinese Patent Application No. 202310439600.7, filed on Apr. 23, 2023, each entitled “SERVICE PROCESSING METHOD AND APPARATUS, COMPUTER DEVICE, AND STORAGE MEDIUM”, and each of which is incorporated herein by reference in its entirety.

### FIELD

This application relates to the field of computer technologies, and in particular, to a service processing technology. More particularly, aspects described here in relate to the simulation and rendering of hair in virtual environments.

### BACKGROUND

With the rapid development of computer technologies, services (for example, a game service, and a film and television special effect production service) have increasingly urgent requirements on a real-time virtual hair dynamic effect. The real-time virtual hair dynamic effect refers to simulating a dynamic effect of virtual hairs of a service character (for example, a service character such as a game character or a film and television production character) in a service in a real-time scenario (for example, a scenario in which there are 30 frames or more of pictures per second), so that the dynamic effect can be as close to a dynamic effect of real hairs in a real scenario as possible. This has very high requirements on realism and real-time performance of dynamic effect simulation on the virtual hairs.

Currently, the dynamic effect of the virtual hairs may be simulated by using a physical simulation policy. However, high-accuracy dynamic effect simulation is performed on the virtual hairs by using the physical simulation policy, resulting in low efficiency and large overheads, and a current hardware level is difficult to implement the high accuracy dynamic effect simulation. Therefore, how to effectively improve the efficiency of the dynamic effect simulation on the virtual hairs and reduce the overheads of the dynamic effect simulation on the virtual hairs becomes a current research hotspot.

### SUMMARY

Aspects described herein provide a service processing method and apparatus, a computer device, and a storage medium, to effectively improve efficiency of dynamic effect simulation on virtual hairs, and reduce overheads of dynamic effect simulation on the virtual hairs.

An aspect described herein provides a service processing method, performed by a computer device. The service processing method includes:
obtaining a hair root point cloud of a service character in a service, the hair root point cloud including hair root points corresponding to a plurality of virtual hairs of the service character;
obtaining sampling control information, the sampling control information being configured for controlling a distance between sampling points in a sampling process of the hair root point cloud;
sampling the hair root point cloud according to the sampling control information, to obtain sampling points; and
determining virtual hairs corresponding to the sampling points as simulated virtual hairs, and determining virtual hairs corresponding to hair root points other than the sampling points in the hair root point cloud as interpolated virtual hairs,
dynamic effect simulation being performed on the simulated virtual hairs by using a physical simulation policy in an execution process of the service, and the simulated virtual hairs being configured for controlling the interpolated virtual hairs to move with the simulated virtual hairs in the execution process of the service.

Correspondingly, an aspect described herein provides a service processing apparatus, deployed on a computer device. The service processing apparatus includes:
an obtaining unit, configured to obtain a hair root point cloud of a service character in a service, the hair root point cloud including hair root points corresponding to a plurality of virtual hairs of the service character, and
the obtaining unit being further configured to obtain sampling control information, the sampling control information being configured for controlling a distance between sampling points in a sampling process of the hair root point cloud; and
a processing unit, configured to sample the hair root point cloud according to the sampling control information, to obtain sampling points,
the processing unit being further configured to determine virtual hairs corresponding to the sampling points as simulated virtual hairs, and determine virtual hairs corresponding to hair root points other than the sampling points in the hair root point cloud as interpolated virtual hairs, and

dynamic effect simulation being performed on the simulated virtual hairs by using a physical simulation policy in an execution process of the service, and the simulated virtual hairs being configured for controlling the interpolated virtual hairs to move with the simulated virtual hairs in the execution process of the service.

Correspondingly, an aspect described herein provides a computer device. The computer device includes:
a processor, suitable for implementing a computer program; and
a computer-readable storage medium, the computer-readable storage medium having a computer program stored therein, and the computer program being suitable being loaded by the processor to perform the service processing method.

Correspondingly, an aspect described herein provides a computer-readable storage medium, the computer-readable storage medium having a computer program stored therein. The computer program, when read and executed by a processor of a computer device, causes the computer device to perform the service processing method.

Correspondingly, an aspect described herein provides a computer program product, including a computer program. The computer program is stored in a computer-readable storage medium. A processor of a computer device reads the computer program from the computer-readable storage medium, and the processor executes the computer program to cause the computer device to perform the service processing method.

In this aspect described herein, sampling of virtual hairs is converted into sampling of hair root points corresponding to the virtual hairs, and a hair root point cloud of a service character in a service may be sampled, to obtain sampling points. Virtual hairs corresponding to the sampling points may be used as simulated virtual hairs, and virtual hairs corresponding to hair root points other than the sampling points in the hair root point cloud may be used as interpolated virtual hairs. Dynamic effect simulation may be performed on the simulated virtual hairs by using a physical simulation policy in an execution process of the service, and the simulated virtual hairs may be configured for controlling the interpolated virtual hairs to move with the simulated virtual hairs in the execution process of the service. In other words, some virtual hairs (the simulated virtual hairs) may be sampled from virtual hairs, and dynamic effect simulation is performed on some virtual hairs by using the physical simulation policy, and remaining virtual hairs (the interpolated virtual hairs) move with the simulated virtual hairs. The dynamic effect simulation does not need to be performed on all the virtual hairs by using the physical simulation policy. In this way, efficiency of the dynamic effect simulation on the virtual hairs can be improved, and overheads of the dynamic effect simulation on the virtual hairs can be reduced. In addition, in a sampling process of the hair root point cloud, a distance between the sampling points is controlled by using sampling control information, and the sampling points can be evenly distributed in the hair root point cloud, so that the sampling points can relatively accurately reflect the original hair root point cloud, and the hair root points corresponding to the simulated virtual hairs can be properly sampled from the hair root point cloud, that is, the simulated virtual hairs can be properly sampled from the virtual hairs. In this way, realism of the dynamic effect simulation on the virtual hairs can be effectively improved, thereby improving the efficiency of the dynamic effect simulation on the virtual hairs and reducing the overheads of the dynamic effect simulation on the virtual hairs while improving the realism of the dynamic effect simulation on the virtual hairs.

### BRIEF DESCRIPTION OF THE DRAWINGS

To describe the technical solutions in the aspects described herein or the related art more clearly, the accompanying drawings required for describing the aspects or the related art are briefly introduced below. Apparently, the accompanying drawings in the following description show merely some aspects described herein, and a person of ordinary skill in the art may still derive other drawings from these accompanying drawings without creative efforts.

FIG. 1 is a schematic diagram of a virtual hair according to an aspect described herein.

FIG. 2 is a schematic structural diagram of a service processing system according to an aspect described herein.

FIG. 3 is a schematic flowchart of a service processing method according to an aspect described herein.

FIG. 4 is a schematic diagram of a voxel grid set according to an aspect of the present application.

FIG. 5 is a schematic diagram of establishing a mapping between a voxel grid and a hair root point according to an aspect described herein.

FIG. 6 is a schematic diagram of a sampling process according to an aspect described herein.

FIG. 7 is a schematic diagram of a sampling result according to an aspect described herein.

FIG. 8 is a schematic flowchart of another service processing method according to an aspect described herein.

FIG. 9 is a schematic diagram of determining a matching simulated virtual hair according to an aspect described herein.

FIG. 10 is a schematic diagram of determining a matching hair segment of a hair point according to an aspect described herein.

FIG. 11 is a schematic diagram of a projection of a hair point in a matching hair segment according to an aspect described herein.

FIG. 12 is a schematic diagram of an interface of a debugging tool according to an aspect described herein.

FIG. 13 is a schematic diagram of comparison between sampling results according to an aspect described herein.

FIG. 14 is a schematic diagram of comparison between interpolation results according to an aspect described herein.

FIG. 15 is a schematic structural diagram of a service processing apparatus according to an aspect described herein.

FIG. 16 is a schematic structural diagram of a computer device according to an aspect described herein.

### DETAILED DESCRIPTION

The technical solutions in the aspects described herein are clearly and completely described in the following with reference to the accompanying drawings in the aspects described herein. The described aspects are merely some rather than all of the aspects described herein. All other aspects obtained by a person of ordinary skill in the art based on the aspects described herein without making creative efforts shall fall within the protection scope described herein.

The aspects described herein relate to dynamic effect simulation on virtual hairs of a service character in a service, e.g., a digital service.

The service may be a service scenario in which dynamic effect simulation needs to be performed on the virtual hairs. For example, the service may include a game, a digital player, or film special effect production.

The service character may be a virtual object in which dynamic effect simulation needs to be performed on the virtual hairs in the service scenario, and the service character may be a virtual character model obtained through modeling. Classification is performed from a modeling dimension. The service character may include a three-dimensional character, a 2.5-dimensional character, a two-dimensional character, or the like. A dimension of the service character is not limited in this aspect described herein. Classification is performed from a service scenario type. The service character may include a game character, a digital player character, a film and television production character, or the like. Classification is performed from a service character type. The service character may include a person, an animal, or the like.

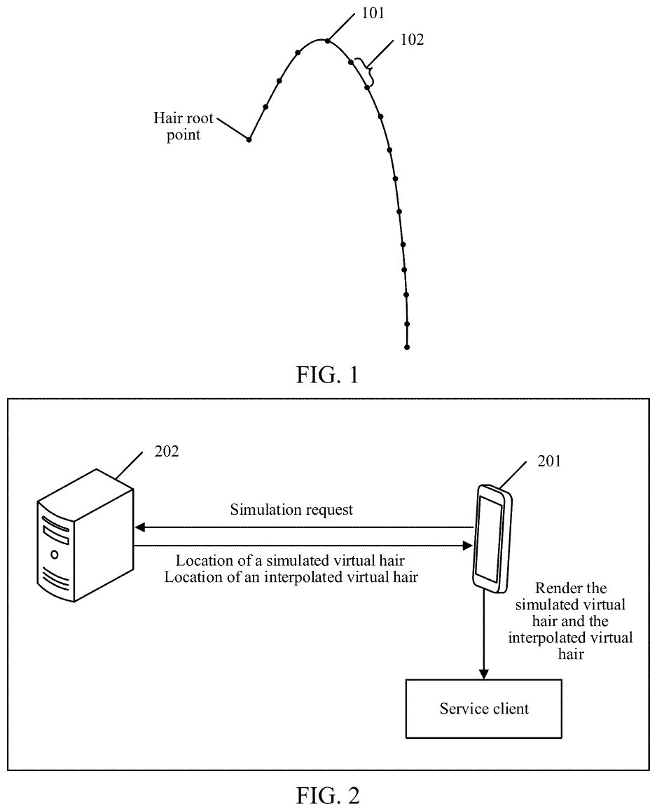

The virtual hair may be a hair model obtained through modeling. As shown in FIG. 1, the virtual hair may include a plurality of hair points 101 and a hair segment 102 between the hair points. A hair point of the plurality of hair points that is connected to a scalp may be referred to as a hair root point.

The dynamic effect simulation on the virtual hairs may refer to simulating a dynamic effect of the virtual hairs of the service character in the service in an execution process of the service, so that the dynamic effect can be as close to a dynamic effect of real hairs in a real scenario as possible. The execution process of the service is usually a real-time scenario. For example, in a real-time game battle, or in a real-time film and television special effect production process, the real-time scenario usually needs to meet a case in which there are 30 frames or more of pictures played back per second, that is, the dynamic effect simulation on the virtual hairs has a very high requirement on real-time performance and realism. Based on this, an aspect described herein provides a service processing method. The service processing method is configured for performing dynamic effect simulation on virtual hairs, and the dynamic effect simulation on the virtual hairs may be implemented based on a sampling-interpolation framework.

1. In a sampling process of the sampling-interpolation framework, some virtual hairs may be sampled from virtual hairs as simulated virtual hairs (or referred to as solved virtual hairs), and remaining virtual hairs are used as interpolated virtual hairs. 2. In an interpolation process of the sampling-interpolation framework, a dynamic effect of the simulated virtual hairs may be simulated by using a physical simulation policy. Simulating the dynamic effect by using the physical simulation policy may be understood as: assigning a physical parameter and a kinematic attribute to each hair point in a virtual hair, calculating interaction forces such as stretching, bending, warping, and collision between hair points, and finally obtaining kinematic attributes (for example, a speed and a location) of the hair points in next frames. There are a plurality of common physical simulation policies, for example, Groom (a physical simulation policy) of an unreal engine (UE) and TressFX (a physical simulation policy) based on an AMD (a graphics card). Advantages of simulating the dynamic effect by using the physical simulation policy are that the simulated dynamic effect is very real, and may interact with another physical system (for example, water, snow, or a collider), but simulating the dynamic effect by using the physical simulation policy has a disadvantage of a relatively slow simulation calculation speed. Especially for a high-accuracy virtual hair, when a quantity of hair points of the virtual hair can often reach a hundred thousand or even a million, a current hardware condition cannot reach a standard that 30 frames or more of pictures are played back per second in a real-time scenario. The interpolated virtual hair may be driven by the simulated virtual hair, and a location of the interpolated virtual hair may be calculated according to a location of the simulated virtual hair, that is, in the execution process of the service, the simulated virtual hair may be configured for controlling the interpolated virtual hair to move with the simulated virtual hair.

According to the service processing method, in the sampling process, sampling of virtual hairs may be converted into sampling of hair root points corresponding to the virtual hairs, the hair root points corresponding to the virtual hairs may be sampled according to sampling control information, to obtain sampling points, virtual hairs corresponding to the sampling points may be used as simulated virtual hairs, and virtual hairs corresponding to hair root points other than the sampling points in a hair root point cloud are used as interpolated virtual hairs. In the sampling process, a distance between the sampling points may be controlled in a sampling process of the hair root points corresponding to the virtual hairs by using the sampling control information. In this way, the sampling points can be evenly distributed in the hair root points corresponding to the virtual hairs, and the sampling points can relatively accurately and comprehensively describe the hair root points corresponding to the virtual hairs, so that the hair root points corresponding to the simulated virtual hairs can be properly sampled from the hair root points corresponding to the virtual hairs, that is, the simulated virtual hairs can be properly sampled from the virtual hairs.

The interpolation process of the service processing method may include an interpolation classification process and an interpolation calculation process. In the interpolation classification process, matching degrees between the simulated virtual hairs and the interpolated virtual hairs may be comprehensively considered from a plurality of perspectives (for example, distances between hair root points corresponding to the simulated virtual hairs and hair root points corresponding to the interpolated virtual hairs, similarities between orientations of the simulated virtual hairs and orientations of the interpolated virtual hairs, and similarities between hair lengths of the simulated virtual hairs and hair lengths of the interpolated virtual hairs), and then simulated virtual hairs having relatively high matching degrees may be selected as matching simulated virtual hairs followed by the interpolated virtual hairs. In the interpolation calculation process, dynamic effect simulation may be performed on the matching simulated virtual hairs of the interpolated virtual hairs by using the physical simulation policy, and the interpolated virtual hairs may move with the matching simulated virtual hairs. In other words, the dynamic effect simulation needs to be performed only on the simulated virtual hairs by using the physical simulation policy rather than on all the virtual hairs by using the physical simulation policy, which can improve efficiency of the dynamic effect simulation on the virtual hairs. In addition, matching simulated virtual hairs having relatively high matching degrees with the interpolated virtual hairs in the simulated virtual hairs may be used as simulated virtual hairs followed by the interpolated virtual hairs, which can improve realism of the dynamic effect simulation performed on the interpolated virtual hairs.

When the service mentioned in the aspects described herein is a game, the game may be an electronic game product, and an electronic game may be an interaction game that is run depending on an electronic device platform. The electronic game may include a standalone game and a network game. The network game may also be referred to as an online game, and generally may be a sustainable personalized multiplayer online game that uses the Internet as a propagation medium, uses a game server and a player terminal as game processing devices, and uses a game client that is run in the player terminal as an information exchange window, and aims at achieving entertainment, leisure, communication, and virtual achievements. The game client is a program that corresponds to the game server and that provides a local game service for a player participating in the network game. The game server is a service device that provides data calculation, verification, storage, and forwarding functions for the game client. The standalone game is an electronic game that can be independently run by using a computer or another game platform. The standalone game can be run normally without the game server.

For the network game, a game type of the network game is not limited in the aspects described herein. For example, the network game may be a cloud game, or the network game may be a common network game. The common network game is a game that is directly run in the game client installed in the player terminal. The cloud game may also be referred to as a game on demand, and is a game that is run in the game server. In other words, in a cloud game scenario, all cloud games are not run in the game client in the player terminal, but run in the game server. The game server compresses and encodes a game picture and game audio in the cloud game into a media stream, and then transmits the media stream to the game client in the player terminal by using a network for image display and audio play. It can be learned that the game client does not need to have strong graphics processing and data computing capabilities, but only needs to have a basic streaming media playback capability and a capability of obtaining an operation instruction inputted by a game player and sending the operation instruction inputted by the game player to the game server. When a game player performs various operations on a game interface of the game client, the game client reports operation data generated by the operations to the game server. The game server refreshes a game picture of the cloud game in the corresponding cloud game according to the operation data, and then returns a refreshed game picture to the game client for display, so as to implement play of the cloud game. In other words, a difference between the common network game and the cloud game lies in that the common network game is run in the game client installed in the player terminal, while the cloud game is run in the game server, and the game client is responsible for presenting a game picture, playing back game audio, and receiving an operation instruction inputted by the game player.

A service processing system suitable for implementing the service processing method provided in the aspects described herein is described below.

As shown in FIG. 2, the service processing system includes a terminal 201 and a server 202. A service client (for example, service software, a service application program, a service webpage, or a service mini program) may be run in the terminal 201. The server 202 may be a data processing server of the service client. A direct communication connection may be established between the terminal 201 and the server 202 in a wired communication manner, or an indirect communication connection may be established in a wireless communication manner. The terminal 201 may include, but is not limited to, any one of the following: a smartphone, a tablet computer, a notebook computer, a desktop computer, a smartwatch, a smart appliance, a smart vehicle-mounted terminal, an aircraft, and the like. The server 202 may be a standalone physical server, may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, an artificial intelligence platform, and the like.

It can be learned from the foregoing content that the service processing method provided in this aspect described herein may include the sampling process and the interpolation process, and the interpolation process may include the interpolation classification process and the interpolation calculation process. In the sampling process, simulated virtual hairs may be sampled from virtual hairs of a service character in a service, and interpolated virtual hairs are virtual hairs other than the simulated virtual hairs in the virtual hairs. In the interpolation classification process, matching simulated virtual hairs having relatively high matching degrees with the interpolated virtual hairs may be selected from the sampled simulated virtual hairs. In the interpolation calculation process, a dynamic effect of the matching simulated virtual hairs may be simulated by using a physical simulation policy, locations of the matching simulated virtual hairs at different moments (for example, in different frames) are determined, and locations of the interpolated virtual hairs at different moments may be calculated according to the locations of the matching simulated virtual hairs at different moments, so as to simulate a dynamic effect of the interpolated virtual hairs.

Based on this, in the service processing system including the terminal 201 and the server 202, for an approximate processing process of the service processing method, reference may be made to the following descriptions: When the service client run in the terminal 201 has a simulation requirement on a dynamic effect of virtual hairs of a service character (for example, when a game battle is started in the service client, or when film and television special effect production is started in the service client), the service client may send a simulation request for the dynamic effect of the virtual hairs of the service character to the server 202 by using the terminal 201. After receiving the simulation request, the server 202 may perform a sampling process, an interpolation classification process, and an interpolation calculation process of a first frame, to obtain locations of matching simulated virtual hairs in the first frame (specifically, a location of each hair point in the matching simulated virtual hairs in the first frame) and locations of interpolated virtual hairs in the first frame (specifically, a location of each hair point in the interpolated virtual hairs in the first frame). Then, the server 202 may send the locations of the matching simulated virtual hairs in the first frame, and the locations of the interpolated virtual hairs in the first frame to the terminal 201. The service client in the terminal 201 may render the matching simulated virtual hairs and the interpolated virtual hairs in a picture of the first frame according to the locations of the matching simulated virtual hairs in the first frame and the locations of the interpolated virtual hairs in the first frame.

Then, the server 202 may perform an interpolation calculation process (performed frame by frame) of a subsequent frame of the first frame, to obtain locations of the matching simulated virtual hairs in the subsequent frame and locations of the interpolated virtual hairs in the subsequent frame. The server 202 may send the locations of the matching simulated virtual hairs in the subsequent frame and the locations of the interpolated virtual hairs in the subsequent frame to the terminal 201. The service client in the terminal 201 may render the matching simulated virtual hairs and the interpolated virtual hairs in a picture of the subsequent frame according to the locations of the matching simulated virtual hairs in the subsequent frame and the locations of the interpolated virtual hairs in the subsequent frame. The rest can be deduced by analogy, until the simulation requirement of the service client run in the terminal 201 on the dynamic effect of the virtual hairs of the service character ends (for example, the game battle in the service client ends, or the film and television special effect production in the service client ends).

The foregoing content describes a general process of the service processing method in the service processing system, and is applicable to a service such as a common network game or film and television special effect production. Particularly, for a cloud game service, a process of the service processing method in the service processing system has some differences from the foregoing process, which are specifically as follows. In the foregoing general process, the matching simulated virtual hairs and the interpolated virtual hairs in each frame of picture are rendered by the service client run in the terminal 201 according to locations of the matching simulated virtual hairs in each frame and locations of the interpolated virtual hairs in each frame. However, in the cloud game service, the matching simulated virtual hairs and the interpolated virtual hairs in each frame of picture are rendered by the server 202 according to the locations of the matching simulated virtual hairs in each frame and the locations of the interpolated virtual hairs in each frame, and the server 202 may send each frame of picture obtained through rendering to the service client in the terminal 201 for presentation.

The service processing system shown in FIG. 2 is merely used as an example. In some services, the service processing system may have other cases. For example, in a standalone game service, the service processing system may include the terminal 201 and does not include the server 202. When the service client run in the terminal 201 has a simulation requirement on a dynamic effect of virtual hairs of a service character (for example, when a game battle is started in the service client, or when film and television special effect production is started in the service client), a sampling process, an interpolation classification process, and an interpolation calculation process are all performed by the terminal 201. The service client in the terminal 201 may directly render matching simulated virtual hairs and interpolated virtual hairs in each frame of picture according to locations of the matching simulated virtual hairs in each frame and locations of the interpolated virtual hairs in each frame.

The service may include different service stages, and the sampling process, the interpolation classification process, and the interpolation calculation process may be performed at different service stages of the service. In more detail, the service may include a service initialization stage and a service execution stage. The service initialization stage is a stage of loading a service resource required at the service execution stage. The service execution stage is a formal execution stage of the service. The sampling process and the interpolation classification process may be executed at the service initialization stage, and the interpolation calculation process may be executed at the service execution stage. For example, for a game service, the service initialization stage is a game resource loading stage of a game battle, the sampling process and the interpolation classification process may be executed at the resource loading stage of the game battle, the service execution stage is a formal battle stage of the game battle, and the interpolation calculation process may be executed at the formal battle stage of the game battle. Alternatively, the service may include a service character production stage, a service initialization stage, and a service execution stage. The sampling process may be executed at the service character production stage, the interpolation classification process may be executed at the service initialization stage, and the interpolation calculation process may be executed at the service execution stage. For example, for a game service, the service character production stage is a service character modeling stage, the sampling process may be executed at the service character modeling stage, the service initialization stage is a game resource loading stage of a game battle, the interpolation classification process may be executed at the resource loading stage of the game battle, the service execution stage is a formal battle stage of the game battle, and the interpolation calculation process may be executed at the formal battle stage of the game battle.

The service processing system provided in this aspect described herein may properly sample simulated virtual hairs from virtual hairs, and may select, from the sampled simulated virtual hairs, matching simulated virtual hairs having relatively high matching degreed with interpolated virtual hairs for following, to improve realism of dynamic effect simulation on the interpolated virtual hairs. The service processing system described in this aspect described herein is intended to describe the technical solutions in the aspects described herein more clearly, and does not constitute a limitation on the technical solutions provided in the aspects described herein. A person of ordinary skill in the art may learn that, with evolution of a system architecture and emergence of new service scenarios, the technical solutions provided in the aspects described herein are also applicable to similar technical problems.

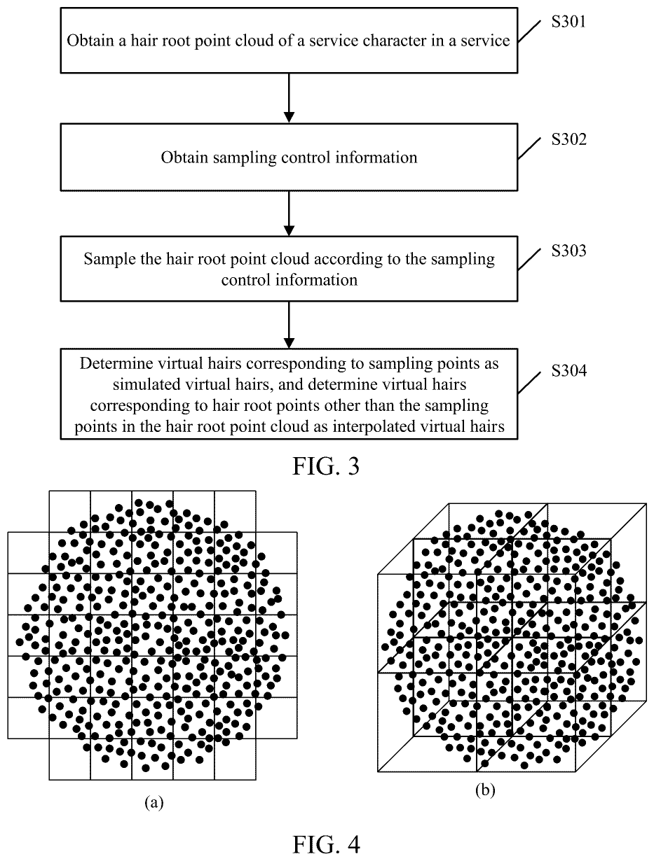

An aspect described herein provides a service processing method. The service processing method mainly describes a sampling process (namely, a sampling process of a hair root point cloud of virtual hairs). The service processing method may be performed by a computer device. The computer device may be a terminal or a server. As shown in FIG. 3, the service processing method may include, but is not limited to, the following operations.

S301: Obtain a hair root point cloud of a service character in a service.

It can be learned from the foregoing content that a virtual hair may include a plurality of hair points and a hair segment between the hair points. A hair point of the plurality of hair points that is connected to a scalp may be referred to as a hair root point. The hair root point cloud may be formed by hair root points corresponding to a plurality of virtual hairs of the service character, that is, the hair root point cloud may include the hair root points corresponding to the plurality of virtual hairs of the service character.

S302: Obtain sampling control information.

The sampling control information may be configured for controlling a distance between sampling points in the sampling process of the hair root point cloud, and a distance between any two sampling points needs to be greater than the sampling control information. In a possible implementation, the sampling control information may be a control radius or a control distance. The sampling control information may be determined in any one of the following manners:

1. The sampling control information may be set by a virtual hair modeler according to hair modeling experience, the virtual hair modeler has abundant hair modeling experience, and the virtual hair modeler can relatively clearly understand a relationship between the sampling control information and a simulation effect of a dynamic effect of a sampled virtual hair. Therefore, the hair root point cloud may be properly sampled based on the sampling control information set by the virtual hair modeler. 2. The sampling control information may be determined according to a quantity of hair root points included in the hair root point cloud. For example, when the quantity of hair root points included in the hair root point cloud is relatively large, a value of the determined sampling control information is relatively large; or when the quantity of hair root points included in the hair root point cloud is relatively small, a value of the determined sampling control information is relatively small. In this way, the sampling control information may adapt to the quantity of hair root points included in the hair root point cloud, and the hair root point cloud can be properly sampled based on the sampling control information adapting to the quantity of hair root points included in the hair root point cloud. 3. The sampling control information may be determined according to distribution information of hair root points in the hair root point cloud. For example, when the hair root points in the hair root point cloud are densely distributed, a value of the determined sampling control information is relatively small; or when the hair root points in the hair root point cloud are sparsely distributed, a value of the determined sampling control information is relatively large. In this way, the sampling control information may adapt to the distribution of the hair root points in the hair root point cloud, and the hair root point cloud can be properly sampled based on the sampling control information adapting to the distribution of the hair root points in the hair root point cloud.

S303: Sample the hair root point cloud according to the sampling control information, to obtain sampling points.

After the hair root point cloud of the service character and the sampling control information are obtained, the hair root point cloud may be sampled according to the sampling control information, to obtain the sampling points. The sampling process of the hair root point cloud may specifically include the following sub-operations.

s11: Generate a voxel grid set according to the sampling control information and location range information of the hair root point cloud.

The location range information of the hair root point cloud may be configured for indicating a location range of each hair root point in the hair root point cloud, and a location of any hair root point in the hair root point cloud is within a location range indicated by the location range information of the hair root point cloud. An example in which the service character is a three-dimensional character is used. The hair root point cloud is located in a three-dimensional space, and a location of a hair root point may be determined by using coordinate values in coordinate directions (for example, an X direction, a Y direction, and a Z direction) in a three-dimensional space coordinate system. A location range of the hair root point cloud may be determined by using a smallest coordinate value and a largest coordinate value in hair root points in the hair root point cloud in each coordinate direction. For example, a location range of the hair root point cloud in the X direction may be determined according to a smallest coordinate value and a largest coordinate value in the hair root points in the hair root point cloud in the X direction, a location range of the hair root point cloud in the Y direction may be determined according to a smallest coordinate value and a largest coordinate value in the hair root points in the hair root point cloud in the Y direction, and a location range of the hair root point cloud in the Z direction may be determined according to a smallest coordinate value and a largest coordinate value in the hair root points in the hair root point cloud in the Z direction. The location range information of the hair root point cloud may be configured for determining a coverage range of the voxel grid set, and the generated voxel grid set can cover the hair root points in the hair root point cloud.

The generated voxel grid set may include a plurality of voxel grids, and sizes of the voxel grids are the same. When the service character is a three-dimensional character, the hair root point cloud is located in a three-dimensional space, and the voxel grid may be a cube in the three-dimensional space. When the service character is a two-dimensional character, the hair root point cloud is located in a two-dimensional space, and the voxel grid may be a square in the two-dimensional space. The cube or the square is used as the voxel grid because the cube or the square has spatial uniformity, helping sampling points in the voxel grids be evenly distributed in the hair root point cloud. The sampling control information may be configured for determining a size of each voxel grid in the voxel grid set. For example, the sampling control information may be configured for determining a side length of the voxel grid, the sampling control information may be configured for determining a distance between a center of the voxel grid and a vertex of the voxel grid, or the sampling control information may be configured for determining a distance between diagonal vertexes of the voxel grid. A manner of determining the size of the voxel grid by using the sampling control information is not limited in this aspect described herein.

A voxel grid set generated based on the sampling control information and location range information of a two-dimensional hair root point cloud is shown in (a) in FIG. 4. The voxel grid set can cover hair root points in the two-dimensional hair root point cloud, that is, each hair root point in the two-dimensional hair root point cloud is located within a coverage range of the generated voxel grid set. A voxel grid set generated based on the sampling control information and location range information of a three-dimensional hair root point cloud is shown in (b) in FIG. 4. The voxel grid set can cover hair root points in the three-dimensional hair root point cloud, that is, each hair root point in the three-dimensional hair root point cloud is located within a coverage range of the generated voxel grid set. In other words, the generated voxel grid set has a full coverage property, and may cover all the hair root points in the hair root point cloud. In this way, outlier hair root points in the hair root point cloud may be sampled in the sampling process, so that the hair root point cloud is sampled more comprehensively.

s12: Establish a mapping between the hair root point cloud and the voxel grid set.

In s11, the voxel grid set may be generated according to the sampling control information and the location range information of the hair root point cloud. However, a belonging relationship between each voxel grid in the generated voxel grid set and each hair root point in the hair root point cloud is unclear. Therefore, the mapping between the hair root point cloud and the voxel grid set needs to be established, that is, a mapping between each hair root point in the hair root point cloud and each voxel grid in the voxel grid set is established. The mapping may be configured for indicating a belonging relationship between a hair root point in the hair root point cloud and a voxel grid in the voxel grid set, that is, establishing the mapping is to determine a voxel grid in the voxel grid set to which each hair root point in the hair root point cloud belongs.

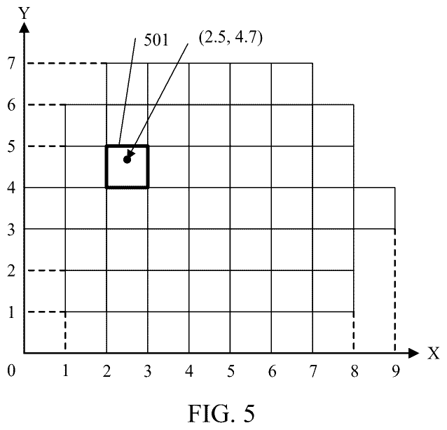

The establishing a mapping between the hair root point cloud and the voxel grid set may specifically include: first selecting a reference point from a space in which the hair root point cloud and the voxel grid set are located, and establishing a coordinate system by using the reference point as an origin of coordinates; then determining location range information of each voxel grid in the coordinate system and location information of each hair root point in the coordinate system; and for any hair root point, determining a voxel grid corresponding to location range information to which location information of the hair root point belongs, and establishing a mapping between the determined voxel grid and the hair root point. A two-dimensional hair root point cloud is used as an example. As shown in FIG. 5, a side length of each voxel grid is sampling control information 1, location range information of a voxel grid 501 in a coordinate system includes location range information [2, 3) in an X direction and location range information [4, 5) in a Y direction, and location information of a hair root point in the coordinate system is coordinates (2.5, 4.7). It can be learned that a coordinate value of the hair root point in the X direction belongs to the location range information of the voxel grid 501 in the X direction, a coordinate value of the hair root point in the Y direction belongs to the location range information of the voxel grid 501 in the Y direction, the hair root point is located in the voxel grid 501, and the hair root point belongs to the voxel grid 501. A mapping between the hair root point and the voxel grid 501 may be established.

s13: Determine, in each voxel grid according to the mapping, a hair root point belonging to the voxel grid, and sample, according to the sampling control information, the hair root point belonging to the voxel grid, to obtain a sampling point in the voxel grid.

Specifically, voxel grids in the voxel grid set may be sequentially sampled in a sampling order. When a sampling voxel grid is a current voxel grid, a hair root point belonging to the current voxel grid may be determined in the current voxel grid according to the mapping, and the hair root point belonging to the current voxel grid is randomly sampled according to the sampling control information. The random sampling may refer to randomly sampling the hair root point belonging to the current voxel grid to obtain a hair root point. If a distance between the randomly sampled hair root point and an existing sampling point is greater than the sampling control information, the randomly sampled hair root point may be determined as a new sampling point. If a quantity of times of random sampling on the current voxel grid reaches a sampling quantity threshold, a hair root point belonging to a next voxel grid of the current voxel grid may be determined according to the mapping, and the hair root point belonging to the next voxel grid is randomly sampled according to the sampling control information until all the voxel grids in the voxel grid set are traversed. In the sampling process, attention needs to be paid to the following several points.

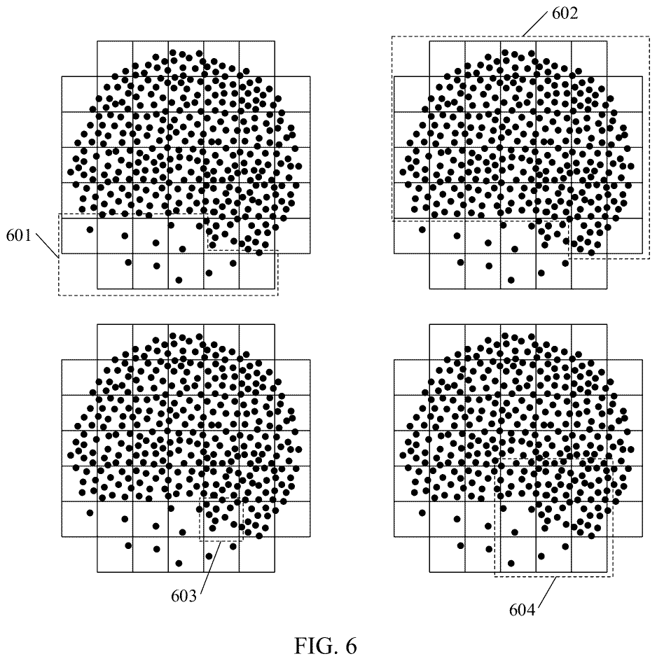

1. Existing sampling points may be sampling points located in the current voxel grid and surrounding voxel grids of the current voxel grid, and the surrounding voxel grids of the current voxel grid may be voxel grids other than the current voxel grid within a surrounding spatial range of the current voxel grid in the voxel grid set. A two-dimensional hair root point cloud is used as an example. As shown in FIG. 6, a square in a dashed box 601 is a sampled voxel grid, a hair root point in the sampled voxel grid is a sampling point, a square in a dashed box 602 is an unsampled voxel grid, and a square in a dashed box 603 is a current voxel grid. Surrounding voxel grids are eight voxel grids other than the current voxel grid within a 3*3 surrounding spatial range (a dashed box 604 shown in FIG. 6) of the current voxel grid. A three-dimensional hair root point cloud is used as an example. Surrounding voxel grids are 26 voxel grids other than the current voxel grid within a 3*3*3 surrounding spatial range of the current voxel grid. In this manner, distances between the randomly sampled hair root point in the current voxel grid and all sampling points do not need to be calculated, and only a distance between the randomly sampled hair root point in the current voxel grid and an existing sampling point within a particular range needs to be calculated, thereby improving overall sampling efficiency. In addition, there may be a plurality of existing sampling points, and the distance compared with the sampling control information may be a smallest distance in distances between the randomly sampled hair root point in the current voxel grid and the existing sampling points. The smallest distance is compared with the sampling control information, so that it can be ensured that a distance between the randomly sampled hair root point in the current voxel grid and any existing sampling point is greater than the sampling control information.

2. In the current voxel grid, in a process of randomly sampling the hair root point belonging to the current voxel grid, a random probability of each hair root point in the current voxel grid may be obtained, and the hair root point belonging to the current voxel grid is randomly sampled according to the random probability of each hair root point and according to the sampling control information. The random probability of each hair root point is positively correlated with a hair length of a virtual hair corresponding to each hair root point. To be specific, a longer hair length of a virtual hair corresponding to a hair root point indicates a larger random probability of the hair root point and a higher probability that the hair root point is sampled, and a shorter hair length of a virtual hair corresponding to a hair root point indicates a smaller random probability of the hair root point and a lower probability that the hair root point is sampled. This is because the virtual hairs corresponding to the sampling points are used as the simulated virtual hairs, when an interpolated virtual hair with a short hair length moves with a simulated virtual hair with a long hair length, a simulated dynamic effect of the interpolated virtual hair is relatively good, and when an interpolated virtual hair with a long hair length moves with a simulated virtual hair with a short hair length, a simulated dynamic effect of the interpolated virtual hair is relatively poor. Therefore, a higher random probability may be assigned to a virtual hair with a relatively long hair length. In this way, it can be ensured that the sampled simulated virtual hair is a virtual hair with a relatively long hair length, thereby improving realism of dynamic effect simulation performed on the interpolated virtual hair.

3. Usually, the sampling quantity threshold may reflect a probability that a sampling point can be obtained through random sampling in a voxel grid. A higher sampling quantity threshold indicates a higher probability that the sampling point can be obtained through random sampling in the voxel grid. A manner of determining the sampling quantity threshold may include: The sampling quantity threshold may be set by a virtual hair modeler according to hair modeling experience. The virtual hair modeler can relatively clearly understand an impact of the sampling quantity threshold on a simulation effect of a dynamic effect of a sampled virtual hair. Therefore, based on a quantity of times of sampling set by the virtual hair modeler, the hair root point cloud may be properly sampled. Alternatively, the sampling quantity threshold corresponding to the current voxel grid may be determined according to a quantity of hair root points included in the current voxel grid. A larger quantity of hair root points included in the current voxel grid indicates a larger determined sampling quantity threshold corresponding to the current voxel grid, and a smaller quantity of hair root points included in the current voxel grid indicates a smaller determined sampling quantity threshold corresponding to the current voxel grid. In this way, the sampling quantity threshold corresponding to the current voxel grid may adapt to the quantity of hair root points included in the current voxel grid. Based on the sampling quantity threshold adapting to the quantity of hair root points included in the current voxel grid, the hair root points in the current voxel grid may be properly sampled.

4. Before the distance between the randomly sampled hair root point and the existing sampling point is compared with the sampling control information, the sampling control information configured for controlling a distance between sampling points in the current voxel grid may be adjusted according to the quantity of hair root points belonging to the current voxel grid. Based on this, if the distance between the randomly sampled hair root point and the existing sampling point is greater than the sampling control information, a manner of determining the randomly sampled hair root point as the new sampling point may be that for the randomly sampled hair root point in the current voxel grid, if the distance between the randomly sampled hair root point and the existing sampling point is greater than adjusted sampling control information, the randomly sampled hair root point may be determined as a new existing sampling point.

In other words, basic sampling control information (namely, the sampling control information set by the virtual hair modeler according to the hair modeling experience, the sampling control information determined according to the quantity of hair root points included in the hair root point cloud, or the sampling control information determined according to the distribution information of the hair root points in the hair root point cloud mentioned in S301) may be first determined. In an actual sampling process, the basic sampling control information may be dynamically adjusted according to a quantity of hair root points in each voxel grid, so that adjusted sampling control information can better adapt to the quantity of hair root points in each voxel grid. Therefore, a hair root point in each voxel grid may be properly sampled based on the adjusted sampling control information. In addition, a quantity of hair root points in a voxel grid can reflect density of the hair root points in the voxel grid. The basic sampling control information is dynamically adjusted, and the adjusted sampling control information can better adapt to density of hair root points in each voxel grid. In this way, density distribution of sampling points can relatively accurately reflect density distribution in the original hair root point cloud, that is, density of the sampling points obtained through sampling is also relatively large in a region in which density of hair root points in the original hair root point cloud is relatively large.

A manner of adjusting the sampling control information is not limited in this aspect described herein. For example, for an illustrative adjustment manner, reference may be made to the following descriptions: The basic sampling control information may correspond to a basic quantity of hair root points, an adjustment amount of the sampling control information and an adjustment direction (for example, increasing or decreasing) of the sampling control information may be determined according to a difference between the quantity of hair root points in the current voxel grid and the basic quantity of hair root points, and then the sampling control information corresponding to the current voxel grid may be adjusted according to the adjustment amount of the sampling control information and according to the adjustment direction of the sampling control information, to obtain adjusted sampling control information. In more detail, the difference between the quantity of hair root points in the current voxel grid and the basic quantity of hair root points is a hair root point quantity difference between the quantity of hair root points in the current voxel grid and the basic quantity of hair root points. If the hair root point quantity difference is greater than a difference threshold (for example, may be 0), it may be determined that the adjustment direction of the sampling control information is an increasing direction. If the hair root point quantity difference is less than a difference threshold (for example, may be 0), it may be determined that the adjustment direction of the sampling control information is a decreasing direction. The adjustment amount of the sampling control information may be determined according to an absolute value (namely, a hair root point quantity change amount) of the hair root point quantity difference. A mapping relationship exists between the hair root point quantity change amount and the adjustment amount of the sampling control information. The hair root point quantity change amount may be mapped to the adjustment amount of the sampling control information based on the mapping relationship. Then, the sampling control information corresponding to the current voxel grid may be adjusted according to the adjustment amount of the sampling control information and according to the adjustment direction of the sampling control information, to obtain the adjusted sampling control information.

For example, the quantity of hair root points in the current voxel grid is 20, the basic quantity of hair root points is 16, and the hair root point quantity difference is 20−16=4, which is greater than the difference threshold 0. In this case, the sampling control information needs to be increased (that is, the adjustment direction of the sampling control information is the increasing direction). The hair root point quantity change amount is 4, and the mapping relationship between the hair root point quantity change amount and the adjustment amount of the sampling control information may be: the adjustment amount of the sampling control information=the hair root point quantity change amount/the basic quantity of hair root points=4/16-0.25, that is, the basic sampling control information needs to be increased by 0.25, to obtain the adjusted sampling control information. Based on this, for a randomly sampled target hair root point in the current voxel grid, if a distance between the randomly sampled target hair root point and the existing sampling point is greater than the adjusted sampling control information, the randomly sampled target hair root point may be determined as a new existing sampling point.

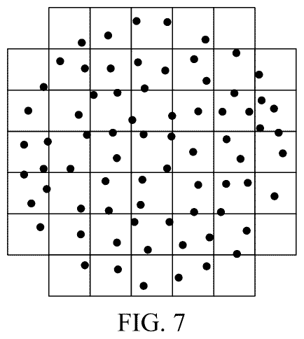

s11 to s13 describe the sampling process of the hair root point cloud. A two-dimensional hair root point cloud is used as an example. FIG. 7 shows a sampling result of the two-dimensional hair root point cloud. A hair root point cloud is denoted as P, any hair root point in the hair root point cloud is denoted as p, a voxel grid set is denoted as G, any voxel grid in the voxel grid set is denoted as g, a current voxel grid is denoted as g′, any hair root point in the current voxel grid is denoted as p′, sampling control information is denoted as R, a mapping between the hair root point cloud before sampling and the voxel grid set is denoted as Map, a mapping between existing sampling points and the voxel grid set is denoted as MapS, a sampling result is denoted as Ps, and any existing sampling point is denoted as ps. For a sampling process of the hair root point cloud, reference may be made to the following pseudocode:

```
  //Build Map between grids and points (build a mapping between the voxel grid set
and the hair root point cloud)
  For every point p in P (for every p in P)
    calculate g from position of p and R (calculate, according to a location of p and R,
g to which p belongs) (1)
    append p to Map(g) (establish a mapping between p and g) (2)
  //Randomly sample in each grid (perform random sampling in each voxel grid)
  For every gird g in G (for each voxel grid g in G):
    for k times do (perform k times of random sampling):
      randomly select a p′ from Map(g′) (randomly sample p′ from g′) (3)
      ps<-all sample points in MapS (g and its neighboring grids) (existing sampling
points in the current voxel grid and surrounding voxel grids of the current voxel grid) (4)
    if dist (p′, ps)>R for all ps (for all ps, if distances between p′ and ps are greater
than R): (5)
        append p′ to Ps and MapS (g′) (determine p′ as a new sampling point and add
the new sampling point to Ps) (6)
        else:
          break
```

In the sampling process of the hair root point cloud, assuming that there are N hair root points in the hair root point cloud P and there are S existing sampling points in the sampling result Ps, in the sampling process of the hair root point cloud shown by the pseudocode, both time complexity of operation (1) (namely, calculating the voxel grid to which the hair root point in the hair root point cloud belongs and time complexity of operation (2) (namely, establishing the mapping between the hair root point cloud and the voxel grid set) are O(N), and both space complexity of operation (1) and space complexity of operation (2) are O(N). Because a quantity of voxel grids in the voxel grid set G is less than N, and time complexity of operation (3) (namely, randomly sampling a hair root point in the current voxel grid) does not exceed O(kN), where k is a sampling quantity threshold, and k is a constant, the time complexity O(kN) is equal to O(N). Time complexity and space complexity of operation (4), operation (5), and operation (6) (namely, calculating whether the distance between the randomly sampled hair root point and the existing sampling point is greater than the sampling control information, and determining the randomly sampled hair root point as the new sampling point if the distance is greater than the sampling control information) are both O(N). This is because a size of a voxel grid is fixed to R and a distance between two sampling points needs to be greater than R. Therefore, a voxel grid in a three-dimensional space is used as an example, a quantity of sampling points in each voxel grid has a constant upper limit of 8 (that is, a maximum quantity of sampling points in each voxel grid is 8), so that time complexity is O(3*3*3*8 kN)=O(kN)=O(N). In other words, time complexity of a sampling manner of the hair root point cloud provided in this aspect described herein is O(N). Compared with a farthest point sampling manner (a manner of first randomly selecting a sampling point from the hair root point cloud, and then selecting a point farthest away from an existing sampling point as a new sampling point each time until a quantity of sampling points or a farthest distance reaches a requirement), when a quantity of sampling points obtained by sampling N hair root points in the farthest point sampling manner is S, time complexity of sampling is O(NS), the sampling process of this aspect described herein has higher sampling efficiency.

S304: Determine virtual hairs corresponding to the sampling points as simulated virtual hairs, and determine virtual hairs corresponding to hair root points other than the sampling points in the hair root point cloud as interpolated virtual hairs.

After the hair root point cloud is sampled according to the sampling control information, to obtain the sampling points, the virtual hairs corresponding to the sampling points may be determined as the simulated virtual hairs, and the virtual hairs corresponding to the hair root points other than the sampling points in the hair root point cloud are determined as the interpolated virtual hairs. Dynamic effect simulation may be performed on the simulated virtual hairs by using a physical simulation policy in an execution process of the service, and the simulated virtual hairs may be configured for controlling the interpolated virtual hairs to move with the simulated virtual hairs in the execution process of the service, that is, a dynamic effect of the interpolated virtual hairs depends on the simulated virtual hairs.

In this aspect described herein, sampling control is performed by using the sampling control information, a smallest distance between any two of the sampling points is greater than the sampling control information, and sampling of the hair root point cloud has a property of the smallest distance. The voxel grid set is generated, each voxel grid in the voxel grid set is used as a sampling unit for sampling, and sampling control is performed by using the sampling control information in the sampling process, so that sampling with relatively uniform spatial distribution can be implemented. Distribution of the sampling points in the hair root point cloud is relatively uniform, and sampling on the hair root point cloud has spatial uniformity. The generated voxel grid set can include all the hair root points in the hair root point cloud. In this way, outlier hair root points in the hair root point cloud may be sampled, and sampling on the hair root point cloud has a full sampling property.

In this aspect described herein, sampling of virtual hairs is converted into sampling of hair root points corresponding to the virtual hairs, and a hair root point cloud of a service character in a service may be sampled, to obtain sampling points. Virtual hairs corresponding to the sampling points may be used as simulated virtual hairs, and virtual hairs corresponding to hair root points other than the sampling points in the hair root point cloud may be used as interpolated virtual hairs. Dynamic effect simulation may be performed on the simulated virtual hairs by using a physical simulation policy in an execution process of the service, and the simulated virtual hairs may be configured for controlling the interpolated virtual hairs to move with the simulated virtual hairs in the execution process of the service. In other words, some virtual hairs (the simulated virtual hairs) may be sampled from virtual hairs, and dynamic effect simulation is performed on some virtual hairs by using the physical simulation policy, and remaining virtual hairs (the interpolated virtual hairs) move with the simulated virtual hairs. The dynamic effect simulation does not need to be performed on all the virtual hairs by using the physical simulation policy. In this way, efficiency of the dynamic effect simulation on the virtual hairs can be improved, and overheads of the dynamic effect simulation on the virtual hairs can be reduced. In addition, in a sampling process of the hair root point cloud, a distance between the sampling points is controlled by using sampling control information, and the sampling points can be evenly distributed in the hair root point cloud, so that the sampling points can relatively accurately reflect the original hair root point cloud, and the hair root points corresponding to the simulated virtual hairs can be properly sampled from the hair root point cloud, that is, the simulated virtual hairs can be properly sampled from the virtual hairs. In this way, realism of the dynamic effect simulation on the virtual hairs can be effectively improved, thereby improving the efficiency of the dynamic effect simulation on the virtual hairs and reducing the overheads of the dynamic effect simulation of the virtual hairs while improving the realism of the dynamic effect simulation on the virtual hairs.

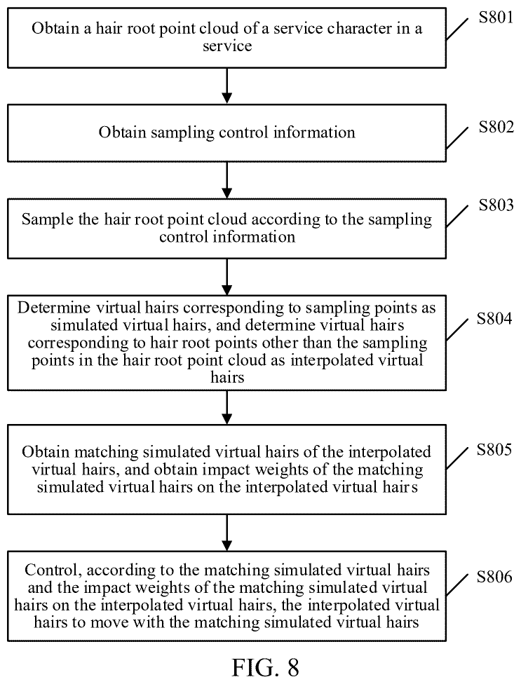

An aspect described herein provides a service processing method. The service processing method mainly describes an interpolation classification process (namely, determining matching simulated virtual hairs of interpolated virtual hairs) and an interpolation calculation process. The service processing method may be performed by a computer device. The computer device may be a terminal or a server. As shown in FIG. 8, the service processing method may include, but is not limited to, the following operations.

S801: Obtain a hair root point cloud of a service character in a service.

S802: Obtain sampling control information.

S803: Sample the hair root point cloud according to the sampling control information, to obtain sampling points.

S804: Determine virtual hairs corresponding to the sampling points as simulated virtual hairs, and determine virtual hairs corresponding to hair root points other than the sampling points in the hair root point cloud as interpolated virtual hairs.

In this aspect described herein, an execution process of S801 is the same as the execution process of S301 in the foregoing aspect shown in FIG. 3, an execution process of S802 is the same as the execution process of S302 in the foregoing aspect shown in FIG. 3, an execution process of S803 is the same as the execution process of S303 in the foregoing aspect shown in FIG. 3, and an execution process of S804 is the same as the execution process of S304 in the foregoing aspect shown in FIG. 3. For a specific execution process, reference may be made to the descriptions in the foregoing aspect shown in FIG. 3, and details are not described herein again.

S805: Obtain matching simulated virtual hairs of the interpolated virtual hairs, and obtain impact weights of the matching simulated virtual hairs on the interpolated virtual hairs.

The matching simulated virtual hairs of the interpolated virtual hairs may be simulated virtual hairs matching the interpolated virtual hairs in the simulated virtual hairs corresponding to the sampling points. In a possible implementation, matching degrees between the simulated virtual hairs and the interpolated virtual hairs may reflect whether the simulated virtual hairs match the interpolated virtual hairs. A higher matching degree between a simulated virtual hair and an interpolated virtual hair indicates a higher possibility that the simulated virtual hair is a matching simulated virtual hair of the interpolated virtual hair. Based on this, a process of obtaining the matching simulated virtual hairs of the interpolated virtual hairs may specifically include the following operations.

For any interpolated virtual hair, matching degrees between the simulated virtual hairs and the interpolated virtual hairs may be determined based on hair features of the simulated virtual hairs and a hair feature of the interpolated virtual hair. Then, the matching simulated virtual hairs of the interpolated virtual hair may be selected from the simulated virtual hairs according to the matching degrees between the simulated virtual hairs and the interpolated virtual hair.

Based on actual experience, some simulated virtual hairs are located around the interpolated virtual hair, and may be matching simulated virtual hairs of the interpolated virtual hair. Some simulated virtual hairs are relatively far away from the interpolated virtual hair, and basically do not match the interpolated virtual hair, that is, basically are not the matching simulated virtual hairs of the interpolated virtual hair. In this case, to avoid unnecessary matching degree calculation and accelerate a matching degree calculation process, matching degrees between some simulated virtual hairs and the interpolated virtual hair may be calculated. To be specific, a manner of determining the matching degrees between the simulated virtual hairs and the interpolated virtual hair may be determining surrounding simulated virtual hairs of the interpolated virtual hair from the simulated virtual hairs, and further determining matching degrees between the surrounding simulated virtual hairs and the interpolated virtual hair based on hair features of the surrounding simulated virtual hairs and the hair feature of the interpolated virtual hair. The surrounding simulated virtual hairs are some simulated virtual hairs of which matching degrees need to be calculated.

The surrounding simulated virtual hairs of the interpolated virtual hair may be simulated virtual hairs corresponding to sampling points in a voxel grid in which a hair root point corresponding to the interpolated virtual hair is located and in surrounding voxel grids of the voxel grid. The surrounding voxel grids of the voxel grid may be voxel grids other than the voxel grid in the voxel grid set within a surrounding spatial range (for example, a 3*3 surrounding spatial range in a two-dimensional space or a 3*3*3 surrounding spatial range in a three-dimensional space) of the voxel grid.

In this manner, matching degrees between the interpolated virtual hair and all the simulated virtual hairs do not need to be calculated, and only the matching degrees between the interpolated virtual hair and the surrounding simulated virtual hairs of the interpolated virtual hair need to be calculated, so that unnecessary matching degree calculation can be avoided, and the matching degree calculation process can be accelerated.

A hair feature of any virtual hair may include location information of a hair root point corresponding to the virtual hair and attribute information of the virtual hair. A manner of determining the matching degrees between the surrounding simulated virtual hairs and the interpolated virtual hair based on the hair features of the surrounding simulated virtual hairs and the hair feature of the interpolated virtual hair may be determining hair root distance information between the surrounding simulated virtual hairs and the interpolated virtual hair according to location information of hair root points corresponding to the surrounding simulated virtual hairs and location information of a hair root point corresponding to the interpolated virtual hair; determining attribute similarities between the surrounding simulated virtual hairs and the interpolated virtual hair according to attribute information of the surrounding simulated virtual hairs and attribute information of the interpolated virtual hair; and determining the matching degrees between the surrounding simulated virtual hairs and the interpolated virtual hair according to the hair root distance information and the attribute similarities.

In a possible implementation, the attribute information may include at least one of orientation information and length information, the orientation information may be a direction in which a hair root point of a virtual hair points to a particular location point of the virtual hair, and the particular location point may be a location point that is in the virtual hair and that is at a particular length (for example, the particular length may be ⅓ of a hair length of the virtual hair) away from the hair root point. A matching degree between any simulated virtual hair and the interpolated virtual hair is a feature similarity between a hair feature of the simulated virtual hair and the hair feature of the interpolated virtual hair, that is, a similarity degree between the simulated virtual hair and the interpolated virtual hair in terms of features such as locations of hair root points, hair orientations, and hair lengths. An example in which the attribute information includes the orientation information is used. For a manner of determining a matching degree between any simulated virtual hair and the interpolated virtual hair, reference may be made to the following formula 1:

$$Score ( T , G ) = \frac{- log ( 1 - {D ( T )}^{T} D ( G ) )}{1 + {‖ R ( G ) - R ( T ) ‖}^{2}} \qquad formula 1$$

As shown in the foregoing formula 1, T represents the simulated virtual hair, G represents the interpolated virtual hair, D(T) represents location information of a hair root point corresponding to the simulated virtual hair, D(G) represents location information of a hair root point corresponding to the interpolated virtual hair, R(T) represents orientation information of the simulated virtual hair, and R(G) represents orientation information of the interpolated virtual hair. The design of the manner for calculating the matching degree between the simulated virtual hair and the interpolated virtual hair shown in formula 1 has the property that a closer distance between the hair root point corresponding to the simulated virtual hair and the hair root point corresponding to the interpolated virtual hair indicates that orientations are more similar and the matching degree is higher.

Based on this, a process of selecting the matching simulated virtual hairs of the interpolated virtual hairs from the simulated virtual hairs according to the matching degrees between the simulated virtual hairs and the interpolated virtual hairs may specifically include: selecting the matching simulated virtual hairs of the interpolated virtual hairs from the surrounding simulated virtual hairs according to a principle of preference of a high matching degree, a quantity of matching simulated virtual hairs being M, and M being an integer greater than or equal to 2, for example, a quantity of matching simulated virtual hairs is three. A manner of obtaining the impact weights of the matching simulated virtual hairs on the interpolated virtual hairs may be determining, according to a proportion of a matching degree corresponding to each of the matching simulated virtual hairs in an overall matching degree of the matching simulated virtual hairs, an impact weight corresponding to each of the matching simulated virtual hairs. The overall matching degree of the matching simulated virtual hairs may be a sum of matching degrees of the matching simulated virtual hairs.

In other words, in this aspect described herein, the matching degrees between the simulated virtual hairs and the interpolated virtual hairs may be comprehensively considered from a plurality of perspectives (for example, distances between hair root points corresponding to the simulated virtual hairs and hair root points corresponding to the interpolated virtual hairs, and attribute (at least one of an orientation and a hair length) similarities between the simulated virtual hairs and the interpolated virtual hairs). A higher matching degree indicates a shorter distance between a simulated virtual hair and an interpolated virtual hair, and a higher attribute (at least one of the orientation and the hair length) similarity between the simulated virtual hair and the interpolated virtual hair. Then, simulated virtual hairs having relatively high matching degrees may be selected from the simulated virtual hairs as matching simulated virtual hairs for simulating a dynamic effect of the interpolated virtual hairs. The matching simulated virtual hairs are relatively close to the interpolated virtual hairs, and attribute information such as orientations and hair lengths is similar. When the dynamic effect of the interpolated virtual hairs is simulated by using the matching simulated virtual hairs, realism of dynamic effect simulation on the interpolated virtual hairs can be improved. In addition, virtual hair modalities such as an orientation and a length are considered for selection of the matching simulated virtual hairs, and realism of dynamic effect simulation on relatively complex virtual hair styling such as a middle parting hair style is relatively high.

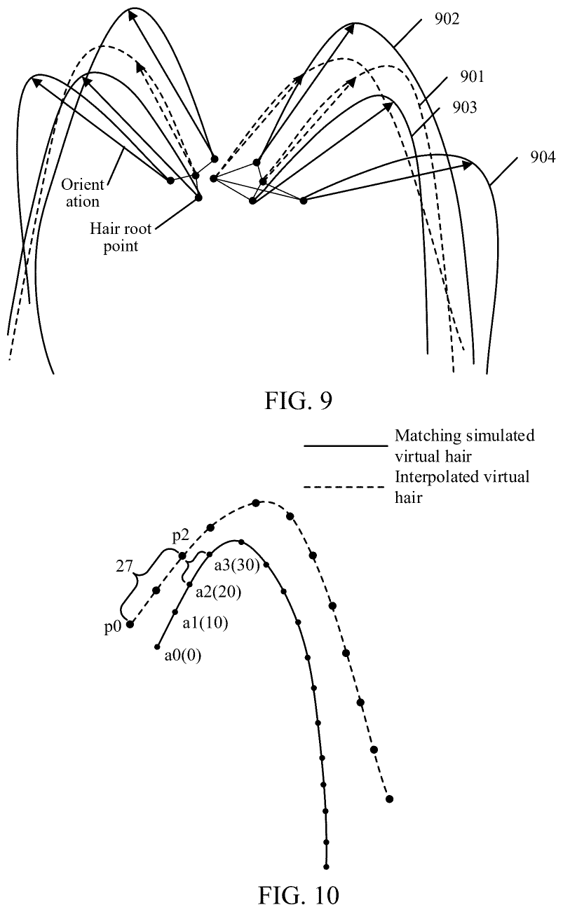

As shown in FIG. 9, simulated virtual hairs in FIG. 9 are represented as solid lines, dots connected to the simulated virtual hairs are hair root points corresponding to the simulated virtual hairs, interpolated virtual hairs are represented as dashed lines, and dots connected to the interpolated virtual hairs are hair root points corresponding to the interpolated virtual hairs. A simulated virtual hair 902, a simulated virtual hair 903, and a simulated virtual hair 904 that are relatively close to the interpolated virtual hair 901 and whose orientations are similar to that of the interpolated virtual hair 901 are selected from surrounding simulated virtual hairs of the interpolated virtual hair 901 as matching simulated virtual hairs of the interpolated virtual hair 901. Connection lines respectively between a hair root point corresponding to the interpolated virtual hair 901 and a hair root point corresponding to the simulated virtual hair 902, a hair root point corresponding to the simulated virtual hair 903, and a hair root point corresponding to the simulated virtual hair 904 represent a driving relationship between the interpolated virtual hair 901 and the simulated virtual hair 902, the simulated virtual hair 903, and the simulated virtual hair 904. The interpolated virtual hair 901 is driven by the simulated virtual hair 902, the simulated virtual hair 903, and the simulated virtual hair 904.

In a possible implementation, when a quantity of surrounding simulated virtual hairs is less than M, or when the matching degrees between the surrounding simulated virtual hairs and the interpolated virtual hairs are relatively low (for example, the matching degrees are lower than a matching degree threshold, and the matching degree threshold may be set by a virtual hair modeler according to hair modeling experience), and M matching simulated virtual hairs are not enough to be selected, a selection range of the surrounding simulated virtual hairs may be expanded, that is, a surrounding spatial range of a voxel grid is expanded (for example, in a two-dimensional space, a 3*3 surrounding spatial range is expanded to a 4*4 surrounding spatial range, and in a three-dimensional space, a 3*3*3 surrounding spatial range is expanded to a 4*4*4 surrounding spatial range), to select a sufficient quantity of matching simulated virtual hairs.

S806: Control, according to the matching simulated virtual hairs and the impact weights of the matching simulated virtual hairs on the interpolated virtual hairs, the interpolated virtual hairs to move with the matching simulated virtual hairs.

After the matching simulated virtual hairs of the interpolated virtual hairs and the impact weights of the matching simulated virtual hairs on the interpolated virtual hairs are obtained, the interpolated virtual hairs may be controlled to move with the matching simulated virtual hairs according to the matching simulated virtual hairs and the impact weights of the matching simulated virtual hairs. The controlling the interpolated virtual hairs to move with the matching simulated virtual hairs may be specifically that: In a first frame, initial interpolation location information of each hair point in the interpolated virtual hairs may be calculated according to location information of related hair points in the matching simulated virtual hairs and the impact weights of the matching simulated virtual hairs. In each frame after the first frame, the initial interpolation location information of each hair point in the interpolated virtual hairs may be updated according to updated location information of the related hair points in the matching simulated virtual hairs and the impact weights of the matching simulated virtual hairs.

To understand the process of controlling the interpolated virtual hairs by using the matching simulated virtual hairs more clearly, a quantity of matching simulated virtual hairs of any interpolated virtual hair may be denoted as M. Herein, any hair point (which may be represented as a to-be-processed hair point) in the interpolated virtual hair is used as an example, to describe the process of controlling movement of the to-be-processed hair point by using M matching simulated virtual hairs. In an actual execution process of the service, processes of calculating all hair points in a same interpolated virtual hair may be parallel, and processes of calculating all interpolated virtual hairs may also be parallel. In this way, overall efficiency of dynamic effect simulation on the interpolated virtual hairs can be improved, and real-time performance of the dynamic effect simulation on the interpolated virtual hairs can be improved. The process of controlling movement of the to-be-processed hair point by using the M matching simulated virtual hairs may specifically include the following sub-operations.

s21: Determine, in each of the M matching simulated virtual hairs, a matching hair segment matching a to-be-processed hair point in the interpolated virtual hairs.

Any virtual hair includes a plurality of hair points and a hair segment between two adjacent hair points. One matching hair segment matching the to-be-processed hair point may be determined in one matching simulated virtual hair, that is, a total of M matching hair segments may be determined in the M matching simulated virtual hairs. That the to-be-processed hair point matches the matching hair segment may mean that a distance between the to-be-processed hair point and a hair root point is close to distances between hair points at two ends of the matching hair segment and the hair root point. The distances between the hair points at the two ends of the matching hair segment and the hair root point may form a distance range between the matching hair segment and the hair root point. If the distance between the to-be-processed hair point and the hair root point falls within the distance range corresponding to the matching hair segment, it may be considered that the to-be-processed hair point matches the matching hair segment. As shown in FIG. 10, a matching simulated virtual hair is represented as a solid line, and dots in the matching simulated virtual hair include a hair root point and other hair points corresponding to the matching simulated virtual hair. An interpolated virtual hair is represented as a dashed line, and dots in the interpolated virtual hair include a hair root point and other hair points corresponding to the interpolated virtual hair. A distance between a to-be-processed hair point p2 in the interpolated virtual hair and a hair root point p0 corresponding to the interpolated virtual hair is 27, a distance range corresponding to a hair segment a2a3 in the matching simulated virtual hair is [20, 30), and the distance between the to-be-processed hair point p2 and the hair root point p0 falls within the distance range corresponding to the hair segment a2a3, so that the hair segment a2a3 in the matching simulated virtual hair may be determined as a matching hair segment matching the to-be-processed hair point p2.

s22: Calculate initial interpolation location information of the to-be-processed hair point according to impact weights of the M matching simulated virtual hairs and location information of the M matching hair segments.

Specifically, interpolation location component information of the to-be-processed hair point under a corresponding matching hair segment may be calculated according to location information of each of the M matching hair segments. The location information of the matching hair segment may include location information of hair points at two ends of the matching hair segment. Weighted summation processing is performed on interpolation location component information of the to-be-processed hair point under the M matching hair segments according to the impact weights of the M matching simulated virtual hairs, to obtain the initial interpolation location information of the to-be-processed hair point. An impact weight of any matching simulated virtual hair is configured for performing weighted processing on interpolation location component information under a matching hair segment in the matching simulated virtual hair.

Any matching hair segment (which may be represented as a to-be-processed hair segment) in the M matching hair segments is used as an example. A process of calculating an interpolation location component information of the to-be-processed hair point under the to-be-processed hair segment according to location information of the to-be-processed hair segment may include the following operations.

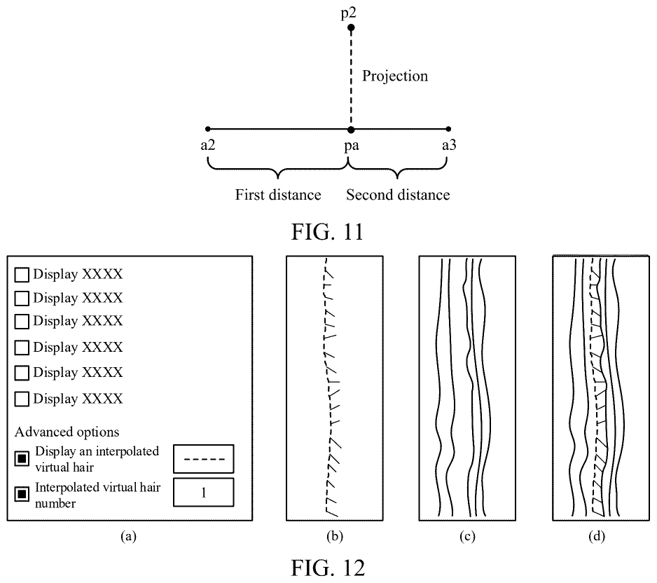

First, the to-be-processed hair point may be projected into the to-be-processed hair segment, hair points at two ends of the to-be-processed hair segment being a first hair point and a second hair point, and a first distance between the first hair point and a projection point of the to-be-processed hair point and a second distance between the second hair point and the projection point of the to-be-processed hair point may be determined. As shown in FIG. 11, the to-be-processed hair point p2 is projected into the hair segment a2a3, a projection point is pa, a distance of a line segment a2pa (namely, a distance between a hair point a2 and the projection point pa) is a first distance, and a distance of a line segment a3pa (namely, a distance between a hair point a3 and the projection point pa) is a second distance. Second, a first weight corresponding to the first hair point may be determined according to a proportion of the first distance in a length of the to-be-processed hair segment. The first weight may be configured for performing weighted processing on location information of the first hair point. In addition, a second weight corresponding to the second hair point may be determined according to a proportion of the second distance in the length of the to-be-processed hair segment. The second weight may be configured for performing weighted processing on location information of the second hair point. Then, weighted summation processing may be performed on the location information of the first hair point and the location information of the second hair point according to the first weight and the second weight, to obtain the interpolation location component information of the to-be-processed hair point under the to-be-processed hair segment.

For ease of understanding the process of calculating the initial interpolation location information of the to-be-processed hair point, the to-be-processed hair point in the interpolated virtual hair may be denoted as p, and a quantity of matching simulated virtual hairs of the interpolated virtual hair is three, which are respectively a matching simulated virtual hair a, a matching simulated virtual hair b, and a matching simulated virtual hair c. A matching hair segment, of the to-be-processed hair point p, in the matching simulated virtual hair a is a matching hair segment aᵢaᵢ₊₁, a matching hair segment, of the to-be-processed hair point p, in the matching simulated virtual hair b is a matching hair segment bᵢbᵢ₊₁, and a matching hair segment, of the to-be-processed hair point p, in the matching simulated virtual hair c is a matching hair segment cᵢcᵢ₊₁. For a process of calculating initial interpolation location information of the to-be-processed hair point p, reference may be made to the following formula 2:

$${p}_{w} = {\sum }_{x} {W}_{x} ( {w}_{{x}_{i}} {x}_{i} + {w}_{{x}_{i + 1}} {x}_{i + 1} ) , x ∈ \{ a , b , c \} \qquad formula 2$$

In the foregoing formula 2, p_{w} represents the initial interpolation location information of the to-be-processed hair point p; Wₓ, x∈{a, b, c} indicates an impact weight of each matching simulated virtual hair, Wₐ represents an impact weight of the matching simulated virtual hair a, W_{b} represents an impact weight of the matching simulated virtual hair b, W_{c} represents an impact weight of the matching simulated virtual hair c, and Wₐ+W_{b}+W_{c}=1; and xᵢ and xᵢ₊₁, x∈{a, b, c} indicate location information of hair points at two ends of a matching hair segment xᵢxᵢ₊₁, Wₓ_{ᵢ} represents a first weight configured for performing weighted processing on the location information xᵢ of the hair point, wₓ_{ᵢ₊₁} represents a second weight configured for performing weighted processing on the location information xᵢ₊₁ of the hair point, and

$${w}_{{x}_{i}} + {w}_{{x}_{i + 1}} = 1.$$

s23: Update the initial interpolation location information of the to-be-processed hair point according to the impact weights of the M matching simulated virtual hairs and updated location information of the M matching hair segments.

The impact weights of the matching simulated virtual hairs comprehensively consider factors such as the distances between the hair root points corresponding to the matching simulated virtual hairs and the hair root points of the interpolated virtual hairs and the attribute similarities between the matching simulated virtual hairs and the interpolated virtual hairs. Therefore, the initial interpolation location information of the to-be-processed hair point is usually different from original location information of the to-be-processed hair point, and the original location information of the to-be-processed hair point is location information carried when the to-be-processed hair point is loaded to the service. Based on this, for a principle of updating the initial interpolation location information of the to-be-processed hair point in this aspect described herein, reference may be made to the following descriptions: In a first frame, offset information between the initial interpolation location information of the to-be-processed hair points and the original location information of the to-be-processed hair point is recorded. In each frame after the first frame, new interpolation location information of the to-be-processed hair point is calculated, the offset information is corrected, and final interpolation location information of the to-be-processed hair point is calculated according to corrected offset information and the new interpolation location information. Specifically, the process of updating the initial interpolation location information of the to-be-processed hair point may include the following operations 1 to 4.

1. Determine the offset information of the to-be-processed hair point according to a difference between the initial interpolation location information of the to-be-processed hair point and the original location information of the to-be-processed hair point. For details, reference may be made to the following formula 3:

$${e}_{w} = p - {p}_{w} \qquad formula 3$$

In the foregoing formula 3, e_{w} represents the offset information, p represents the original location information of the to-be-processed hair point, and p_{w} represents the initial interpolation location information of the to-be-processed hair point.

2. Calculate reference interpolation location information of the to-be-processed hair point according to the impact weights of the M matching simulated virtual hairs and the updated location information of the M matching hair segments. A process of calculating the reference interpolation location information of the to-be-processed hair point is similar to the process of calculating the initial interpolation location information of the to-be-processed hair point. For details, reference may be made to the foregoing process of calculating the initial interpolation location information of the to-be-processed hair point. The process of calculating the reference interpolation location information of the to-be-processed hair point may be represented as the following formula 4:

$${p}_{w}^{′} = {\sum }_{x ′} {W}_{x} ( {w}_{{x}_{i}^{′}} {{x}^{′}}_{i} + {w}_{{x}_{i + 1}^{′}} {{x}^{′}}_{i + 1} ) , {x}^{′} ∈ \{ {a}^{′} , {b}^{′} , {c}^{′} \} \qquad formula 4$$

In the foregoing formula 4,

$${p}_{w}^{′}$$

represents the reference interpolation location information of the to-be-processed hair point; Wₓ, x∈{a, b, c} indicates an impact weight of each matching simulated virtual hair, Wₐ represents an impact weight of the matching simulated virtual hair a, W_{b} represents an impact weight of the matching simulated virtual hair b, W_{c} represents an impact weight of the matching simulated virtual hair c, and Wₐ+W_{b}+W_{c}=1; x′ and x′ᵢ₊₁, x′∈{a′, b′, c′} represent updated location information of hair points at two ends of a matching hair segment x′ᵢx′ᵢ₊₁ (namely, updated location information of the to-be-processed hair segment), a′ represents an updated matching simulated virtual hair a, b′ represents an updated matching simulated virtual hair b, and c′ represents an updated matching simulated virtual hair c; and

$${w}_{{x}_{i}^{′}}$$

represents a first weight configured for performing weighted processing on the location information x′ᵢ of the hair point,

$${w}_{{x}_{i + 1}^{′}}$$

represents a second weight configured for performing weighted processing on the location information x′ᵢ₊₁ of the hair point, and

$${w}_{{x}_{i}^{′}} + {w}_{{x}_{i + 1}^{′}} = 1.$$

3. Determine location transformation information according to a difference between the updated location information of the M matching hair segments and the location information of the M matching hair segments before updating. A process of determining the location transformation information may include: calculating a first location information change amount of hair points at two ends of each matching hair segment before updating, and calculating a second location information change amount of the hair points at the two ends of each matching hair segment after updating; determining, according to a difference between the first location information change amount and the second location information change amount of each matching hair segment, a transformation matrix corresponding to the matching hair segment; and determining a transformation matrix of a reference hair segment in the M matching hair segments as the location transformation information, the reference hair segment being a matching hair segment in a matching simulated virtual hair having a largest impact weight in the M matching simulated virtual hairs.

Location information change amounts of hair points at two ends of each matching hair segment before and after updating may be calculated, and for each matching hair segment, a transformation matrix enabling the location information change amount before updating to be transformed into the location information change amount after updating is calculated, and then a transformation matrix corresponding to a matching hair segment in a matching simulated virtual hair having a largest impact weight in a plurality of matching simulated virtual hairs may be determined as location transformation information. For example, dₓ=xᵢ₊₁−xᵢ, x∈{a, b, c} represents a location information change amount of a matching hair segment before updating (namely, the first location information change amount), dₓ, =x′ᵢ₊₁−x′i, x∈{a′, b′, c′} represents a location information change amount of the matching hair segment after updating (namely, the second location information change amount), and dₓ may be transformed into dₓ, by using a transformation matrix

$${R}_{x}^{′} .$$

In this aspect described herein, the transformation matrix corresponding to x*=argmax_{x∈{a,b,c}}Wₓ is used as the location transformation information R′_{w}, that is,

$${{R}^{′}}_{w} = {R}_{{x}^{′}}^{′} .$$

4. Correct the offset information of the to-be-processed hair point according to the location transformation information, to obtain corrected offset information. For details, reference may be made to the following formula 5. Then, summation processing may be performed on the reference interpolation location information and the corrected offset information of the to-be-processed hair point, to obtain updated interpolation location information of the to-be-processed hair point. For details, reference may be made to the following formula 6.

$${e}_{w}^{′} = {{R}^{′}}_{w} {e}_{w} \qquad formula 5$$

$${p}^{′} = {p}_{w}^{′} + {e}_{w}^{′} \qquad formula 6$$

In the foregoing formula 5,

$${e}_{w}^{′}$$

represents the corrected offset information, e_{w} represents the offset information before the correction, and R′_{w} represents the location transformation information. In the foregoing formula 6,

$${p}_{w}^{′}$$

represents the reference interpolation location information of the to-be-processed hair point,

$${e}_{w}^{′}$$

represents the corrected offset information, and p′ represents the updated interpolation location information of the to-be-processed hair point.

The foregoing s21 to s23 describe the process of controlling, according to the matching simulated virtual hairs and the impact weights of the matching simulated virtual hairs, the interpolated virtual hairs to move with the matching simulated virtual hairs. In the process, for a hair point in the interpolated virtual hairs, a matching hair segment is determined in each matching simulated virtual hair, and interpolation location information is calculated, so that accuracy of calculation of the interpolation location information of the hair point in the interpolated virtual hairs can be improved, thereby improving realism of dynamic effect simulation on the hair point in the interpolated virtual hairs. In addition, after a dynamic effect of the matching simulated virtual hairs is updated, in addition to calculating new interpolation location information of the hair point in the interpolated virtual hairs, offset information is further introduced to correct the calculated new interpolation location information, so that the accuracy of the calculation of the interpolation location information of the hair point in the interpolated virtual hairs can be further improved, thereby further improving the realism of the dynamic effect simulation on the hair point in the interpolated virtual hairs.

In addition, the process, described in s21 to s23, of controlling, according to the matching simulated virtual hairs and the impact weights of the matching simulated virtual hairs, the interpolated virtual hairs to move with the matching simulated virtual hairs is applicable to the sampling-interpolation framework, and may be further applied to another manner of determining the interpolated virtual hairs and the matching simulated virtual hairs of the interpolated virtual hairs. For example, existing virtual hairs may be used as the interpolated virtual hairs, the matching simulated virtual hairs of the interpolated virtual hairs and the impact weights of the matching simulated virtual hairs on the interpolated virtual hairs are additionally generated, and then the interpolated virtual hairs are controlled to move with the matching simulated virtual hairs according to the matching simulated virtual hairs and the impact weights of the matching simulated virtual hairs. This manner can be applied to any virtual hair, and can effectively resolve a problem that virtual hairs has an uneven modality, resulting in low realism of dynamic effect simulation on the interpolated virtual hairs. For another example, existing virtual hairs may be used as simulated virtual hairs, interpolated virtual hairs of the simulated virtual hairs and impact weights of the simulated virtual hairs on the interpolated virtual hairs are additionally generated, and then the interpolated virtual hairs are controlled to move with the simulated virtual hairs according to the simulated virtual hairs and the impact weights of the simulated virtual hairs. This manner can be applied to any virtual hair, and can effectively resolve a problem that virtual hairs has an uneven modality, resulting in low realism of dynamic effect simulation on the interpolated virtual hairs.

In this aspect described herein, content described in s21 and s22 in S805 and S806 belongs to the interpolation classification process, and content described in s23 belongs to the interpolation calculation process. In the interpolation calculation process described in s23, the impact weight of each matching simulated virtual hair on the interpolated virtual hair is fixed. In some aspects, an impact weight of each matching simulated virtual hair on the interpolated virtual hair may dynamically change in each frame.

Specifically, in an implementation, the impact weights of the matching simulated virtual hairs on the interpolated virtual hairs in each frame may be obtained through recalculation according to the matching degrees between the matching simulated virtual hairs and the interpolated virtual hairs. In more detail, after dynamic effect simulation is performed on the matching simulated virtual hairs by using the physical simulation policy in a current frame, a matching degree between each matching simulated virtual hair and the interpolated virtual hair may be recalculated. The impact weight of each matching simulated virtual hair on the interpolated virtual hair may be calculated according to the recalculated matching degree between each matching simulated virtual hair and the interpolated virtual hair. For a calculation manner of the impact weight, reference may be made to the related content described in S805. In this manner, the impact weights of the matching simulated virtual hairs on the interpolated virtual hairs and the matching degrees of current modalities of the matching simulated virtual hairs are higher. In this way, realism of dynamic effect simulation on the interpolated virtual hairs can be improved.

In another implementation, the impact weights of the matching simulated virtual hairs on interpolated virtual hairs in each frame may be obtained through prediction by using a neural network model. In more detail, in a model training process, the neural network model may be obtained through training by using a large quantity of simulated virtual hairs as training sample data. The simulated virtual hairs used as the training sample data may be from virtual hairs of different styles. In this way, the neural network model obtained through training can be applied to the virtual hairs of different styles, and impact weight prediction can be accurately performed by using the neural network model obtained through training for the virtual hairs of different styles. In a model prediction process, after dynamic effect simulation is performed on the matching simulated virtual hairs by using the physical simulation policy in the current frame, the matching simulated virtual hairs and the interpolated virtual hairs may be inputted into the neural network model for impact weight prediction, to obtain the impact weights of the matching simulated virtual hairs on the interpolated virtual hairs. In this manner, the impact weights of the matching simulated virtual hairs on the interpolated virtual hairs and the matching degrees of current modalities of the matching simulated virtual hair are higher, and the neural network model can be reserved. In this way, realism of dynamic effect simulation on the interpolated virtual hairs can be improved. Particularly, in addition to predicting the impact weights of the matching simulated virtual hairs, the neural network model further predicts the interpolation calculation process. After dynamic effect simulation is performed on the matching simulated virtual hairs by using the physical simulation policy in the current frame, the matching simulated virtual hairs and the interpolated virtual hairs may be inputted into the neural network model, and the neural network model may directly predict interpolation location information of each hair point in the interpolated virtual hairs in the current frame. In this manner, according to a model training method, more modality features of the matching simulated virtual hairs can be learned, and more details and layers are reserved, so that realism of dynamic effect simulation on the interpolated virtual hairs can be improved.

In this aspect described herein, matching degrees between the simulated virtual hairs and the interpolated virtual hairs may be comprehensively considered from a plurality of perspectives (for example, distances between hair root points corresponding to the simulated virtual hairs and hair root points corresponding to the interpolated virtual hairs, and attribute (at least one of an orientation and a hair length) similarities between the simulated virtual hairs and the interpolated virtual hairs). Then, simulated virtual hairs having relatively high matching degrees may be selected from the simulated virtual hairs as matching simulated virtual hairs for simulating a dynamic effect of the interpolated virtual hairs. The matching simulated virtual hairs are relatively close to the interpolated virtual hairs, and attribute information such as orientations and hair lengths is similar. When the dynamic effect of the interpolated virtual hairs is simulated by using the matching simulated virtual hairs, realism of dynamic effect simulation on the interpolated virtual hairs can be improved.

The detailed execution process of the service processing method is mainly described in the foregoing aspects shown in FIG. 3 and FIG. 8. Based on this, related technical supports of the service processing method are described below.

The service processing method provided in this aspect described herein may be integrated into a service processing engine (for example, a service processing engine in a game service may be an unreal engine 5 (UE 5)), and the service processing engine may be provided for use in a form of a plug-in (for example, a PhysionGroot plug-in). In the PhysionGroot plug-in, a real-time dynamic effect of a matching simulated virtual hair may be simulated by using physical simulation policies such as an MPM (a physical simulation policy) and a DER (another physical simulation policy), and may be implemented based on C++ (a compiled language) and hlsl (another compiled language). During implementation, in this aspect described herein, parallel computing may be accelerated by using a graphics processing unit (GPU), and a debugging tool may be developed. Specifically,

Parallel acceleration: Because interpolation calculation processes of interpolated virtual hairs are independent of each other and do not interfere with each other, the processes may be accelerated through parallel computing. In this aspect described herein, the GPU may be invoked in a manner of a compute shader for calculation. A thread block in units of 128 is used. That the thread block in the units of 128 is used means that each thread block processes 128 points simultaneously. Each block is divided into four thread groups (warps). Threads in each thread group process calculation of a same interpolated virtual hair. Each thread is responsible for calculating one hair point. Division of the thread group conforms to a hardware structure of the GPU, and is also consistent with an existing data structure of the PhysionGroot plug-in. Each thread block processes 128 points simultaneously, and the GPU can pull up a plurality of thread blocks simultaneously according to a calculation resource situation. In this way, time consumption can be reduced by several orders of magnitudes through parallel computing, thereby improving realism of dynamic effect simulation on the interpolated virtual hairs.

Debugging tool: in this aspect described herein, a debugging tool for the interpolation calculation process may be provided in the service processing engine. The debugging tool may read hair point data in the GPU during running, invoke a primary draw interface (PDI) of the service processing engine, and may draw various attributes of virtual hairs in a scene. In a service development or test process, the debugging tool may help a service developer or tester to quickly position a problem that exists in the interpolation calculation process. An interface of the debugging tool is shown in FIG. 12. A number of an interpolated virtual hair that needs to be positioned and a display form of the interpolated virtual hair may be specified in an interface (a) of the debugging tool. The display form may be, for example, a display color or a display line style. The debugging tool can read a mapping relationship between a simulated virtual hair and the interpolated virtual hair that is stored during previous calculation, and visualize the mapping relationship. An interpolated virtual hair of a designated number is shown in (b) in FIG. 12. As shown in (b) in FIG. 12, one end of a line segment is connected to a hair point in the interpolated virtual hair, and the other end is configured for being connected to a hair point in a matching simulated virtual hair of the interpolated virtual hair. A shade of a color of the line segment may be configured for indicating that an impact weight of the connected matching simulated virtual hair on the interpolated virtual hair. Simulated virtual hairs (solid lines shown in (c) in FIG. 12) in virtual hairs are shown in (c) in FIG. 12. The simulated virtual hairs (solid lines shown in (d) in FIG. 12), the interpolated virtual hair (a dashed line shown in (d) in FIG. 12), and a matching simulated virtual hair (namely, a simulated virtual hair connected to the interpolated virtual hair by using a line segment) connected to the interpolated virtual hair are simultaneously presented in (d) in FIG. 12.

An experimental result of the service processing method provide in this aspect described herein is described below.

According to the service processing method provided in this aspect described herein, the sampling process, the interpolation classification process, and the interpolation calculation process are innovated. A sampling effect and an interpolation effect of a virtual hair are significantly improved by using the service processing method provided in this aspect described herein.

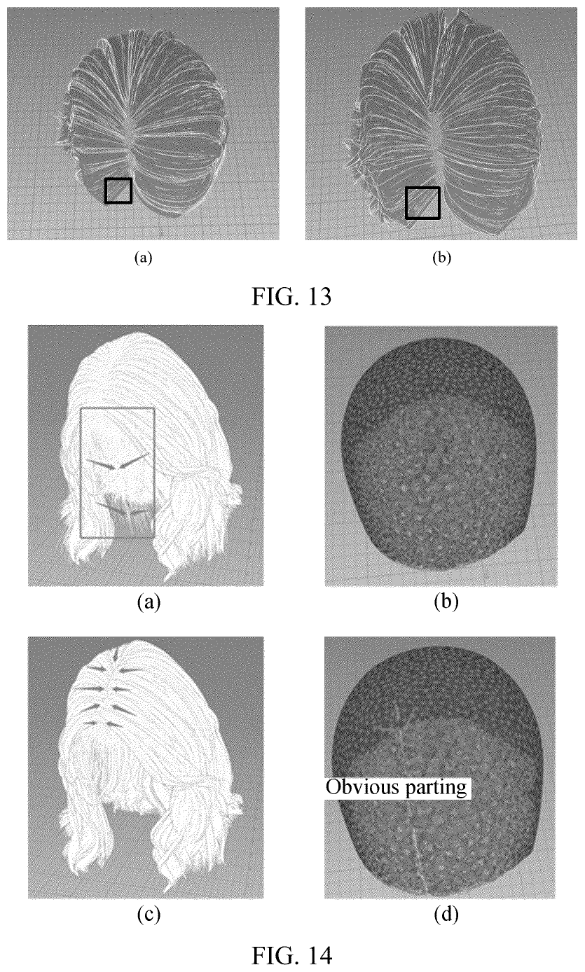

In terms of the sampling effect, compared with simple random sampling (that is, some hair root points are randomly sampled from a hair root point cloud as hair root points corresponding to simulated virtual hairs), a sampling result in this aspect described herein is that hair root points are distributed more evenly in a space, and it can be ensured that hair root points located at a boundary are included. FIG. 13 shows comparison between sampling results when approximately 6% of hair root points in a hair root point cloud are sampled as hair root points corresponding to simulated virtual hairs in a simple random sampling manner and the sampling manner provided in this aspect described herein. Simulated virtual hairs sampled in the simple random sampling manner are shown in (a) in FIG. 13, and simulated virtual hairs sampled in the sampling manner provided in this aspect described herein are shown in (b) in FIG. 13. It can be learned from the comparison that the simulated virtual hairs sampled in the sampling manner provided in this aspect described herein are more evenly distributed in the space. The sampling manner provided in this aspect described herein ensures that the sampled simulated virtual hairs can include virtual hairs at a boundary. In the simple random sampling manner, virtual hairs at an edge of a rectangular box are not sampled.

In terms of the interpolation effect, in the interpolation manner provided in this aspect described herein, a simulation effect on a middle parting hair style is relatively good, and an error caused by a relatively large form difference between three interpolated virtual hairs does not occur. FIG. 14 shows comparison between interpolation results obtained in a simple interpolation manner (namely, a manner in which a simulated virtual hair closest to an interpolated virtual hair is selected as a matching simulated virtual hair for following) and in an interpolation manner provided in this aspect described herein. A virtual hair interpolation effect in the simple interpolation manner is shown in (a) in FIG. 14, and a hair root point interpolation effect in the simple interpolation manner is shown in (b) in FIG. 14. A larger point indicates a hair root point corresponding to the simulated virtual hair, a smaller point indicates a hair root point corresponding to the interpolated virtual hair, and a connection line between the hair root point corresponding to the simulated virtual hair and the hair root point corresponding to the interpolated virtual hair indicates a driving relationship and a shade of a color of the connection line indicates an impact weight. A virtual hair interpolation effect in the interpolation manner provided in this aspect described herein is shown in (c) in FIG. 14, and a hair root point interpolation effect in the interpolation manner provided in this aspect described herein is shown in (d) in FIG. 14. It can be learned from the comparison that in the simple interpolation manner, interpolation location calculation is performed on a plurality of interpolated virtual hairs by using simulated virtual hairs at two sides, causing the interpolation result to be incorrectly located in the middle. However, the interpolation manner provided in this aspect described herein can avoid such a problem. It can be learned that in the interpolation manner provided in this aspect described herein, a clear discontinuity exists in connection lines between the simulated virtual hairs and the interpolated virtual hairs, and corresponds to a middle parting of a virtual hair style, which proves that hairs at two sides are not selected for interpolation for the interpolated virtual hairs, and there is no clear error in representation of the hairs during actual running.

In terms of overall interpolation efficiency, by using an interpolation algorithm in which parallel computing is accelerated by using the GPU, a test is performed on a UE 5 run on an experimental platform on which a Nvidia 2060 (a graphics card) is installed. For a test result, reference may be made to Table 1.

TABLE 1

| | | Total | Total | Average time |
|---|---|---|---|---|
| | Simulated | quantity | quantity | consumption |
| | hairs | of hairs | of points | (microsecond) |
| Group A | 357 | 24874 | 936567 | 311 |
| Group B | 357 | 35177 | 1438467 | 444 |
| Group C | 1401 | 35177 | 1438467 | 467 |

In general, even if there are a million hair points, performance consumption of the service processing method provided in this aspect described herein is only about 0.5 milliseconds per frame, which completely meets a real-time requirement, and occupies a relatively small proportion of time consumption of a whole simulation algorithm. In addition, the time consumption is only related to a quantity of hair points in the interpolated virtual hairs, and is hardly affected by a quantity of hair points in the simulated virtual hairs.

The method in this aspect described herein is described in detail above. For ease of better implementing the foregoing solutions in the aspects described herein, an apparatus in an aspect described herein is correspondingly provided below.

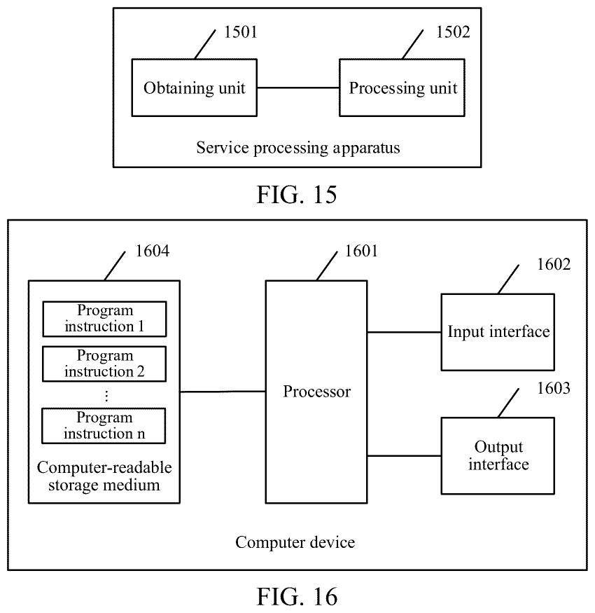

FIG. 15 is a schematic structural diagram of a service processing apparatus according to an aspect described herein. The service processing apparatus may be disposed in a computer device provided in this aspect described herein. The computer device may be a terminal or a server. The service processing apparatus shown in FIG. 15 may be a computer program (including program code) run in the computer device. The service processing apparatus may be configured to implement some or all of the operations in the method aspect shown in FIG. 3 or FIG. 8. Refer to FIG. 15, the service processing apparatus includes the following units:

an obtaining unit 1501, configured to obtain a hair root point cloud of a service character in a service, the hair root point cloud including hair root points corresponding to a plurality of virtual hairs of the service character, and
the obtaining unit 1501 being further configured to obtain sampling control information, the sampling control information being configured for controlling a distance between sampling points in a sampling process of the hair root point cloud; and
a processing unit 1502, configured to sample the hair root point cloud according to the sampling control information, to obtain sampling points,
the processing unit 1502 being further configured to determine virtual hairs corresponding to the sampling points as simulated virtual hairs, and determine virtual hairs corresponding to hair root points other than the sampling points in the hair root point cloud as interpolated virtual hairs, and
dynamic effect simulation being performed on the simulated virtual hairs by using a physical simulation policy in an execution process of the service, and the simulated virtual hairs being configured for controlling the interpolated virtual hairs to move with the simulated virtual hairs in the execution process of the service.

In an implementation, when being configured to sample the hair root point cloud according to the sampling control information, to obtain the sampling points, the processing unit 1502 is specifically configured to perform the following operations:
generating a voxel grid set according to the sampling control information and location range information of the hair root point cloud, the sampling control information being configured for determining a size of each voxel grid in the voxel grid set, and the location range information of the hair root point cloud being configured for determining a coverage range of the voxel grid set;
establishing a mapping between the hair root point cloud and the voxel grid set, the mapping being configured for indicating a belonging relationship between a hair root point in the hair root point cloud and a voxel grid in the voxel grid set; and
determining, in each voxel grid according to the mapping, a hair root point belonging to the voxel grid, and sampling, according to the sampling control information, the hair root point belonging to the voxel grid, to obtain a sampling point in the voxel grid.

In an implementation, voxel grids in the voxel grid set are sequentially sampled in a sampling order. When being configured to determine, in each voxel grid according to the mapping, the hair root point belonging to the voxel grid, and sample, according to the sampling control information, the hair root point belonging to the voxel grid, to obtain the sampling point in the voxel grid, the processing unit 1502 is specifically configured to perform the following operations:
determining, according to the mapping when a sampling voxel grid is a current voxel grid, a hair root point belonging to the current voxel grid, and randomly sampling, according to the sampling control information, the hair root point belonging to the current voxel grid;
determining, if a distance between a randomly sampled hair root point and an existing sampling point is greater than the sampling control information, the randomly sampled hair root point obtained as a new sampling point; and
determining, according to the mapping if a quantity of times of random sampling on the current voxel grid reaches a sampling quantity threshold, a hair root point belonging to a next voxel grid of the current voxel grid, and randomly sampling, according to the sampling control information, the hair root point belonging to the next voxel grid until all the voxel grids in the voxel grid set are traversed.

In an implementation, when being configured to randomly sample, according to the sampling control information, the hair root point belonging to the current voxel grid, the processing unit 1502 is specifically configured to perform the following operations:
obtaining a random probability of each hair root point in the current voxel grid, the random probability of each hair root point being positively correlated with a hair length of a virtual hair corresponding to each hair root point; and
randomly sampling, according to the random probability of each hair root point and according to the sampling control information, the hair root point belonging to the current voxel grid.

In an implementation, the processing unit 1502 is further configured to perform the following operation:
adjusting the sampling control information according to a quantity of hair root points that belong to the current voxel grid.

When being configured to determine, if the distance between the randomly sampled hair root point and the existing sampling point is greater than the sampling control information, the randomly sampled hair root point obtained as the new sampling point, the processing unit 1502 is specifically configured to perform the following operation:
determining, if the distance between the randomly sampled hair root point and the existing sampling point is greater than adjusted sampling control information, the randomly sampled hair root point obtained as the new sampling point.

In an implementation, the obtaining unit 1501 is further configured to perform the following operation:
obtaining matching simulated virtual hairs of the interpolated virtual hairs, and obtaining impact weights of the matching simulated virtual hairs on the interpolated virtual hairs, the matching simulated virtual hairs being simulated virtual hairs matching the interpolated virtual hairs in the simulated virtual hairs corresponding to the sampling points.

The processing unit 1502 is further configured to perform the following operation:
controlling, according to the matching simulated virtual hairs and the impact weights of the matching simulated virtual hairs on the interpolated virtual hairs, the interpolated virtual hairs to move with the matching simulated virtual hairs.

In an implementation, when being configured to obtain the matching simulated virtual hairs of the interpolated virtual hairs, and obtain the impact weights of the matching simulated virtual hairs on the interpolated virtual hairs, the obtaining unit 1501 is specifically configured to perform the following operations:
determining matching degrees between the simulated virtual hairs and the interpolated virtual hairs based on hair features of the simulated virtual hairs and hair features of the interpolated virtual hairs; and
selecting the matching simulated virtual hairs of the interpolated virtual hairs from the simulated virtual hairs according to the matching degrees between the simulated virtual hairs and the interpolated virtual hairs.

In an implementation, when being configured to determine the matching degrees between the simulated virtual hairs and the interpolated virtual hairs based on the hair features of the simulated virtual hairs and the hair features of the interpolated virtual hairs, the obtaining unit 1501 is specifically configured to perform the following operations:
determining surrounding simulated virtual hairs of the interpolated virtual hairs in the simulated virtual hairs; and
determining matching degrees between the surrounding simulated virtual hairs and the interpolated virtual hairs based on hair features of the surrounding simulated virtual hairs and the hair features of the interpolated virtual hairs.

In an implementation, a hair feature of any virtual hair includes location information of a hair root point corresponding to the virtual hair and attribute information of the virtual hair, and when being configured to determine the matching degrees between the surrounding simulated virtual hairs and the interpolated virtual hairs based on the hair features of the surrounding simulated virtual hairs and the hair features of the interpolated virtual hairs, the obtaining unit 1501 is specifically configured to perform the following operations:
determining hair root distance information between the surrounding simulated virtual hairs and the interpolated virtual hairs according to location information of hair root points corresponding to the surrounding simulated virtual hairs and location information of hair root points corresponding to the interpolated virtual hairs;
determining attribute similarities between the surrounding simulated virtual hairs and the interpolated virtual hairs according to attribute information of the surrounding simulated virtual hairs and attribute information of the interpolated virtual hairs; and
determining the matching degrees between the surrounding simulated virtual hairs and the interpolated virtual hairs according to the hair root distance information and the attribute similarities.

In an implementation, when being configured to select the matching simulated virtual hairs of the interpolated virtual hairs from the simulated virtual hairs according to the matching degrees between the simulated virtual hairs and the interpolated virtual hairs, the processing unit 1502 is specifically configured to perform the following operations:
selecting the matching simulated virtual hairs of the interpolated virtual hairs from the surrounding simulated virtual hairs according to a principle of preference of a high matching degree, a quantity of matching simulated virtual hairs being M, and M being an integer greater than or equal to 2; and
when obtaining the impact weights of the matching simulated virtual hairs on the interpolated virtual hairs, the processing unit 1502 is specifically configured to perform the following operations:
determining, according to a proportion of a matching degree corresponding to each of the matching simulated virtual hairs in an overall matching degree of the matching simulated virtual hairs, an impact weight corresponding to each of the matching simulated virtual hairs.

In an implementation, any virtual hair includes a plurality of hair points and a hair segment between two adjacent hair points; a quantity of matching simulated virtual hairs is M, and M is an integer greater than or equal to 2; and when being configured to control, according to the matching simulated virtual hairs and the impact weights of the matching simulated virtual hairs on the interpolated virtual hairs, the interpolated virtual hairs to move with the matching simulated virtual hairs, the processing unit 1502 is specifically configured to perform the following operations:
determining, in each of the M matching simulated virtual hairs, a matching hair segment matching a to-be-processed hair point in the interpolated virtual hairs, one matching hair segment being determined in one matching simulated virtual hair, and a quantity of matching hair segments being M;
calculating initial interpolation location information of the to-be-processed hair point according to impact weights of the M matching simulated virtual hairs and location information of the M matching hair segments; and
updating the initial interpolation location information of the to-be-processed hair point according to the impact weights of the M matching simulated virtual hairs and updated location information of the M matching hair segments.

In an implementation, location information of any matching hair segment includes location information of hair points at two ends of the matching hair segment; and when being configured to calculate the initial interpolation location information of the to-be-processed hair point according to the impact weights of the M matching simulated virtual hairs and the location information of the M matching hair segments, the processing unit 1502 is specifically configured to perform the following operations:
calculating, according to location information of each of the M matching hair segments, interpolation location component information of the to-be-processed hair point under a corresponding matching hair segment; and
performing weighted summation processing on interpolation location component information of the to-be-processed hair point under the M matching hair segments according to the impact weights of the M matching simulated virtual hairs, to obtain the initial interpolation location information of the to-be-processed hair point.

In an implementation, any one of the M matching hair segments represents a to-be-processed hair segment, and hair points at two ends of the to-be-processed hair segment are a first hair point and a second hair point; and when being configured to calculate, according to the location information of each of the M matching hair segments, the interpolation location component information of the to-be-processed hair point under the corresponding matching hair segment, the processing unit 1502 is specifically configured to perform the following operations:
projecting the to-be-processed hair point into the to-be-processed hair segment, determining a first distance between the first hair point and a projection point of the to-be-processed hair point, and determining a second distance between the second hair point and the projection point of the to-be-processed hair point;
determining, according to a proportion of the first distance in a length of the to-be-processed hair segment, a first weight corresponding to the first hair point; determining, according to a proportion of the second distance in the length of the to-be-processed hair segment, a second weight corresponding to the second hair point; and
performing weighted summation processing on location information of the first hair point and location information of the second hair point according to the first weight and the second weight, to obtain the interpolation location component information of the to-be-processed hair point under the to-be-processed hair segment.

In an implementation, each hair point in any virtual hair corresponds to respective original location information; and when being configured to update the initial interpolation location information of the to-be-processed hair point according to the impact weights of the M matching simulated virtual hairs and the updated location information of the M matching hair segments, the processing unit 1502 is specifically configured to the following operations:
determining offset information of the to-be-processed hair point according to a difference between the initial interpolation location information of the to-be-processed hair point and the original location information of the to-be-processed hair point;
calculating reference interpolation location information of the to-be-processed hair point according to the impact weights of the M matching simulated virtual hairs and the updated location information of the M matching hair segments;
determining location transformation information according to a difference between the updated location information of the M matching hair segments and the location information of the M matching hair segments before updating;
correcting the offset information of the to-be-processed hair point according to the location transformation information, to obtain corrected offset information; and
performing summation processing on the reference interpolation location information and the corrected offset information of the to-be-processed hair point, to obtain updated interpolation location information of the to-be-processed hair point.

In an implementation, location information of any matching hair segment includes location information of hair points at two ends of the matching hair segment; and when being configured to determine the location transformation information according to the difference between the updated location information of the M matching hair segments and the location information of the M matching hair segments before updating, the processing unit 1502 is specifically configured to perform the following operations:
calculating a first location information change amount of hair points at two ends of each matching hair segment before updating, and calculating a second location information change amount of the hair points at the two ends of each matching hair segment after updating;
determining, according to a difference between the first location information change amount and the second location information change amount of each matching hair segment, a transformation matrix corresponding to the matching hair segment; and
determining a transformation matrix of a reference hair segment in the M matching hair segments as the location transformation information, the reference hair segment being a matching hair segment in a matching simulated virtual hair having a largest impact weight in the M matching simulated virtual hairs.

According to another aspect described herein, the units of the service processing apparatus shown in FIG. 15 may be separately or wholly combined into one or a plurality of other units, or one (or more) of the units here may further be divided into the plurality of units of smaller functions. In this way, same operations can be implemented, and implementation of the technical effects of aspects described herein is not affected. The units are divided based on logical functions. In actual applications, a function of one unit may be implemented by a plurality of units, or functions of a plurality of units may be implemented by one unit. In another aspect described herein, the service processing apparatus may also include another unit. In actual application, these functions may alternatively be cooperatively implemented by another unit and may be cooperatively implemented by a plurality of units.

According to another aspect described herein, a computer program (including program code) that can perform the operations involved in some or all of the method shown in FIG. 3 or FIG. 8 may be run on a general-purpose computing device such as a computer that includes processing components and storage components such as a central processing unit (CPU), a random access memory (RAM), and a read-only memory (ROM), to construct the service processing apparatus shown in FIG. 15 and implement the service processing method in the aspects described herein. The computer program may be stored in, for example, a computer-readable storage medium, and is installed in the computing device through the computer-readable storage medium, and is run in the computing device.

In this aspect described herein, sampling of virtual hairs is converted into sampling of hair root points corresponding to the virtual hairs, and a hair root point cloud of a service character in a service may be sampled, to obtain sampling points. Virtual hairs corresponding to the sampling points may be used as simulated virtual hairs, and virtual hairs corresponding to hair root points other than the sampling points in the hair root point cloud may be used as interpolated virtual hairs. Dynamic effect simulation may be performed on the simulated virtual hairs by using a physical simulation policy in an execution process of the service, and the simulated virtual hairs may be configured for controlling the interpolated virtual hairs to move with the simulated virtual hairs in the execution process of the service. In other words, some virtual hairs (the simulated virtual hairs) may be sampled from virtual hairs, and dynamic effect simulation is performed on some virtual hairs by using the physical simulation policy, and remaining virtual hairs (the interpolated virtual hairs) move with the simulated virtual hairs. The dynamic effect simulation does not need to be performed on all the virtual hairs by using the physical simulation policy. In this way, efficiency of the dynamic effect simulation on the virtual hairs can be improved, and overheads of the dynamic effect simulation on the virtual hairs can be reduced. In addition, in a sampling process of the hair root point cloud, a distance between the sampling points is controlled by using sampling control information, and the sampling points can be evenly distributed in the hair root point cloud, so that the sampling points can relatively accurately reflect the original hair root point cloud, and the hair root points corresponding to the simulated virtual hairs can be properly sampled from the hair root point cloud, that is, the simulated virtual hairs can be properly sampled from the virtual hairs. In this way, realism of the dynamic effect simulation on the virtual hairs can be effectively improved, thereby improving the efficiency of the dynamic effect simulation on the virtual hairs and reducing the overheads of the dynamic effect simulation on the virtual hairs while improving the realism of the dynamic effect simulation on the virtual hairs.

Based on the foregoing method and apparatus aspects, an aspect described herein provides a computer device. FIG. 16 is a schematic structural diagram of a computer device according to an aspect described herein. The computer device shown in FIG. 16 includes at least a processor 1601, an input interface 1602, an output interface 1603, and a computer-readable storage medium 1604. The processor 1601, the input interface 1602, the output interface 1603, and the computer-readable storage medium 1604 may be connected through a bus or in another manner. The computer-readable storage medium 1604 may be stored in a memory of the computer device. The computer-readable storage medium 1604 is configured to store a computer program. The computer program includes computer instructions. The processor 1601 is configured to execute the program instructions stored in the computer-readable storage medium 1604. The processor 1601 (or referred to as a central processing unit (CPU)) is a computing core and a control core of the computer device, is configured to implement one or more computer instructions, and is specifically configured to load and execute the one or more computer instructions to implement a corresponding method processor a corresponding function.

An aspect described herein further provides a computer-readable storage medium (memory). The computer-readable storage medium is a memory device in a computer device, and is configured to store a program and data. The computer-readable storage medium herein may include an internal storage medium of the computer device, and certainly may also include an expanded storage medium supported by the computer device. The computer-readable storage medium provides storage space, and the storage space stores an operating system of the computer device. In addition, the storage space further stores one or more computer instructions configured to be loaded and executed by a processor. The computer instructions may be one or more computer programs (including program code). The computer-readable storage medium herein may be a high-speed RAM, or a non-volatile memory, for example, at least one disk memory. In some aspects, the computer-readable storage medium may be at least one computer-readable storage medium located far from the foregoing processor.

In some aspects, the computer device may be a terminal or a server, and the processor 1601 may load and execute one or more computer instructions stored in the computer-readable storage medium 1604, to implement corresponding operations in the foregoing service processing method shown in FIG. 3 or FIG. 8. During specific implementation, the computer instructions in the computer-readable storage medium 1604 are loaded by the processor 1601 to perform the service processing method provided in the foregoing aspects.

According to an aspect described herein, a computer program product is provided, including a computer program, the computer program being stored in a computer-readable storage medium. A processor of a computer device reads the computer program from the computer-readable storage medium, and the processor executes the computer program to cause the computer device to perform the service processing method provided in the foregoing aspects.

The foregoing descriptions are merely specific implementations described herein, but are not intended to limit the protection scope described herein. Any variation or replacement readily figured out by a person skilled in the art within the technical scope disclosed in this application shall fall within the protection scope described herein. Therefore, the protection scope described herein shall be subject to the protection scope of the claims.

What is claimed is:

1. A computer-implemented method comprising:
obtaining a hair root point cloud of a service character in a service, the hair root point cloud comprising a plurality of hair root points, where each hair root point corresponds to a different one of a plurality of virtual hairs of the service character;
obtaining sampling control information, the sampling control information being configured for controlling a distance between sampling points in a sampling process of the hair root point cloud;
sampling the hair root point cloud according to the sampling control information, to obtain sampling points; and
determining virtual hairs corresponding to the sampling points as simulated virtual hairs, and determining virtual hairs corresponding to hair root points other than the sampling points in the hair root point cloud as interpolated virtual hairs,
simulating the simulated virtual hairs using a physical simulation policy, and moving the interpolated virtual hairs based on the simulated virtual hairs.

2. The method according to claim 1, wherein the sampling the hair root point cloud comprises:
generating a voxel grid set according to the sampling control information and location range information of the hair root point cloud, the sampling control information being configured for determining a size of each voxel grid in the voxel grid set, and the location range information of the hair root point cloud being configured for determining a coverage range of the voxel grid set;
establishing a mapping between the hair root point cloud and the voxel grid set, the mapping being configured for indicating a belonging relationship between a hair root point in the hair root point cloud and a voxel grid in the voxel grid set; and
determining, in each voxel grid according to the mapping, a hair root point belonging to the voxel grid, and sampling, according to the sampling control information, the hair root point belonging to the voxel grid, to obtain a sampling point in the voxel grid.

3. The method according to claim 2, wherein voxel grids in the voxel grid set are sequentially sampled in a sampling order; and the determining, in each voxel grid according to the mapping, a hair root point belonging to the voxel grid, and sampling, according to the sampling control information, the hair root point belonging to the voxel grid, to obtain a sampling point in the voxel grid comprises:
determining, according to the mapping when a sampling voxel grid is a current voxel grid, a hair root point belonging to the current voxel grid, and randomly sampling, according to the sampling control information, the hair root point belonging to the current voxel grid;
determining, when a distance between a randomly sampled hair root point and an existing sampling point is greater than the sampling control information, the randomly sampled hair root point as a new sampling point; and
determining, according to the mapping when a quantity of times of random sampling on the current voxel grid reaches a sampling quantity threshold, a hair root point belonging to a next voxel grid of the current voxel grid, and randomly sampling, according to the sampling control information, the hair root point belonging to the next voxel grid until all the voxel grids in the voxel grid set are traversed.

4. The method according to claim 3, wherein the randomly sampling, according to the sampling control information, the hair root point belonging to the current voxel grid comprises:
obtaining a random probability of each hair root point in the current voxel grid, the random probability of each hair root point being positively correlated with a hair length of a virtual hair corresponding to each hair root point; and
randomly sampling, according to the random probability of each hair root point and according to the sampling control information, the hair root point belonging to the current voxel grid.

5. The method according to claim 3, wherein the method further comprises:
adjusting the sampling control information according to a quantity of hair root points that belong to the current voxel grid; and
the determining, when the distance between a randomly sampled hair root point and the existing sampling point is greater than the sampling control information, the randomly sampled hair root point as a new sampling point comprises:
determining, when the distance between the randomly sampled hair root point and the existing sampling point is greater than adjusted sampling control information, the randomly sampled hair root point as the new sampling point.

6. The method according to claim 1, wherein the method further comprises:
obtaining matching simulated virtual hairs of the interpolated virtual hairs, and obtaining impact weights of the matching simulated virtual hairs on the interpolated virtual hairs, the matching simulated virtual hairs being simulated virtual hairs matching the interpolated virtual hairs in the simulated virtual hairs corresponding to the sampling points; and
controlling, according to the matching simulated virtual hairs and the impact weights of the matching simulated virtual hairs on the interpolated virtual hairs, the interpolated virtual hairs to move with the matching simulated virtual hairs.

7. The method according to claim 6, wherein the obtaining matching simulated virtual hairs of the interpolated virtual hairs comprises:
determining matching degrees between the simulated virtual hairs and the interpolated virtual hairs based on hair features of the simulated virtual hairs and hair features of the interpolated virtual hairs; and
selecting the matching simulated virtual hairs of the interpolated virtual hairs from the simulated virtual hairs according to the matching degrees between the simulated virtual hairs and the interpolated virtual hairs.

8. The method according to claim 7, wherein the determining matching degrees between the simulated virtual hairs and the interpolated virtual hairs based on hair features of the simulated virtual hairs and hair features of the interpolated virtual hairs comprises:
determining surrounding simulated virtual hairs of the interpolated virtual hairs in the simulated virtual hairs; and
determining matching degrees between the surrounding simulated virtual hairs and the interpolated virtual hairs based on hair features of the surrounding simulated virtual hairs and the hair features of the interpolated virtual hairs.

9. The method according to claim 8, wherein a hair feature of any one of the virtual hairs comprises location information of a hair root point corresponding to the virtual hair and attribute information of the virtual hair, and the determining matching degrees between the surrounding simulated virtual hairs and the interpolated virtual hairs based on hair features of the surrounding simulated virtual hairs and the hair features of the interpolated virtual hairs comprises:
determining hair root distance information between the surrounding simulated virtual hairs and the interpolated virtual hairs according to location information of hair root points corresponding to the surrounding simulated virtual hairs and location information of hair root points corresponding to the interpolated virtual hairs;
determining attribute similarities between the surrounding simulated virtual hairs and the interpolated virtual hairs according to attribute information of the surrounding simulated virtual hairs and attribute information of the interpolated virtual hairs; and
determining the matching degrees between the surrounding simulated virtual hairs and the interpolated virtual hairs according to the hair root distance information and the attribute similarities.

10. The method according to claim 8, wherein the selecting the matching simulated virtual hairs of the interpolated virtual hairs from the simulated virtual hairs according to the matching degrees between the simulated virtual hairs and the interpolated virtual hairs comprises:
selecting the matching simulated virtual hairs of the interpolated virtual hairs from the surrounding simulated virtual hairs according to a principle of preference of a high matching degree, a quantity of matching simulated virtual hairs being M, and M being an integer greater than or equal to 2; and
the obtaining impact weights of the matching simulated virtual hairs on the interpolated virtual hairs comprises:
determining, according to a proportion of a matching degree corresponding to each of the matching simulated virtual hairs in an overall matching degree of the matching simulated virtual hairs, an impact weight corresponding to each of the matching simulated virtual hairs.

11. The method according to claim 6, wherein any virtual hair comprises a plurality of hair points and a hair segment between two adjacent hair points; a quantity of matching simulated virtual hairs is M, and M is an integer greater than or equal to 2; and the controlling, according to the matching simulated virtual hairs and the impact weights of the matching simulated virtual hairs on the interpolated virtual hairs, the interpolated virtual hairs to move with the matching simulated virtual hairs comprises:
determining, in each of the M matching simulated virtual hairs, a matching hair segment matching a to-be-processed hair point in the interpolated virtual hairs, one matching hair segment being determined in one matching simulated virtual hair, and a quantity of matching hair segments being M;
calculating initial interpolation location information of the to-be-processed hair point according to impact weights of the M matching simulated virtual hairs and location information of the M matching hair segments; and
updating the initial interpolation location information of the to-be-processed hair points according to the impact weights of the M matching simulated virtual hairs and updated location information of the M matching hair segments.

12. The method according to claim 11, wherein location information of any one of the matching hair segments comprises location information of hair points at two ends of the matching hair segment; and the calculating initial interpolation location information of the to-be-processed hair point according to impact weights of the M matching simulated virtual hairs and location information of the M matching hair segments comprises:
calculating, according to location information of each of the M matching hair segments, interpolation location component information of the to-be-processed hair point under a corresponding matching hair segment; and
performing weighted summation processing on interpolation location component information of the to-be-processed hair point under the M matching hair segments according to the impact weights of the M matching simulated virtual hairs, to obtain the initial interpolation location information of the to-be-processed hair point.

13. The method according to claim 12, wherein any one of the M matching hair segments is represented as a to-be-processed hair segment, and hair points at two ends of the to-be-processed hair segment are a first hair point and a second hair point; and the calculating, according to location information of each of the M matching hair segments, interpolation location component information of the to-be-processed hair point under a corresponding matching hair segment comprises:
projecting the to-be-processed hair point into the to-be-processed hair segment, determining a first distance between the first hair point and a projection point of the to-be-processed hair point, and determining a second distance between the second hair point and the projection point of the to-be-processed hair point;
determining, according to a proportion of the first distance in a length of the to-be-processed hair segment, a first weight corresponding to the first hair point; determining, according to a proportion of the second distance in the length of the to-be-processed hair segment, a second weight corresponding to the second hair point; and
performing weighted summation processing on location information of the first hair point and location information of the second hair point according to the first weight and the second weight, to obtain interpolation location component information of the to-be-processed hair point under the to-be-processed hair segment.

14. The method according to claim 11, wherein each hair point in any virtual hair corresponds to respective original location information; and the updating the initial interpolation location information of the to-be-processed hair point according to the impact weights of the M matching simulated virtual hairs and updated location information of the M matching hair segments comprises:
determining offset information of the to-be-processed hair point according to a difference between the initial interpolation location information of the to-be-processed hair point and the original location information of the to-be-processed hair point;
calculating reference interpolation location information of the to-be-processed hair point according to the impact weights of the M matching simulated virtual hairs and the updated location information of the M matching hair segments;
determining location transformation information according to a difference between the updated location information of the M matching hair segments and the location information of the M matching hair segments before updating;
correcting the offset information of the to-be-processed hair point according to the location transformation information, to obtain corrected offset information; and
performing summation processing on the reference interpolation location information and the corrected offset information of the to-be-processed hair point, to obtain updated interpolation location information of the to-be-processed hair point.

15. The method according to claim 14, wherein location information of any one of the matching hair segments comprises location information of hair points at two ends of the matching hair segment; and the determining location transformation information according to a difference between the updated location information of the M matching hair segments and the location information of the M matching hair segments before updating comprises:
calculating a first location information change amount of hair points at two ends of each matching hair segment before updating, and calculating a second location information change amount of the hair points at the two ends of each matching hair segment after updating;
determining, according to a difference between the first location information change amount and the second location information change amount of each matching hair segment, a transformation matrix corresponding to the matching hair segment; and
determining a transformation matrix of a reference hair segment in the M matching hair segments as the location transformation information, the reference hair segment being a matching hair segment in a matching simulated virtual hair having a largest impact weight in the M matching simulated virtual hairs.

16. One or more non-transitory computer readable media comprising computer readable instructions which, when executed by a processor, configure a data processing system to perform:
obtaining a hair root point cloud of a service character in a service, the hair root point cloud comprising a plurality of hair root points, where each hair root point corresponds to a different one of a plurality of virtual hairs of the service character;
obtaining sampling control information, the sampling control information being configured for controlling a distance between sampling points in a sampling process of the hair root point cloud;
sampling the hair root point cloud according to the sampling control information, to obtain sampling points; and
determining virtual hairs corresponding to the sampling points as simulated virtual hairs, and determining virtual hairs corresponding to hair root points other than the sampling points in the hair root point cloud as interpolated virtual hairs,
simulating the simulated virtual hairs using a physical simulation policy, and moving the interpolated virtual hairs based on the simulated virtual hairs.

17. The computer readable media of claim 16, wherein the sampling the hair root point cloud comprises:
generating a voxel grid set according to the sampling control information and location range information of the hair root point cloud, the sampling control information being configured for determining a size of each voxel grid in the voxel grid set, and the location range information of the hair root point cloud being configured for determining a coverage range of the voxel grid set;
establishing a mapping between the hair root point cloud and the voxel grid set, the mapping being configured for indicating a belonging relationship between a hair root point in the hair root point cloud and a voxel grid in the voxel grid set; and
determining, in each voxel grid according to the mapping, a hair root point belonging to the voxel grid, and sampling, according to the sampling control information, the hair root point belonging to the voxel grid, to obtain a sampling point in the voxel grid.

18. The computer readable media of claim 17, wherein voxel grids in the voxel grid set are sequentially sampled in a sampling order; and the determining, in each voxel grid according to the mapping, a hair root point belonging to the voxel grid, and sampling, according to the sampling control information, the hair root point belonging to the voxel grid, to obtain a sampling point in the voxel grid comprises:
determining, according to the mapping when a sampling voxel grid is a current voxel grid, a hair root point belonging to the current voxel grid, and randomly sampling, according to the sampling control information, the hair root point belonging to the current voxel grid;
determining, when a distance between a randomly sampled hair root point and an existing sampling point is greater than the sampling control information, the randomly sampled hair root point as a new sampling point; and
determining, according to the mapping when a quantity of times of random sampling on the current voxel grid reaches a sampling quantity threshold, a hair root point belonging to a next voxel grid of the current voxel grid, and randomly sampling, according to the sampling control information, the hair root point belonging to the next voxel grid until all the voxel grids in the voxel grid set are traversed.

19. A system, comprising:
a processor; and
memory storing computer readable instructions which, when executed by the processor, configure the system to perform:
obtaining a hair root point cloud of a service character in a service, the hair root point cloud comprising a plurality of hair root points, where each hair root point corresponds to a different one of a plurality of virtual hairs of the service character;
obtaining sampling control information, the sampling control information being configured for controlling a distance between sampling points in a sampling process of the hair root point cloud;
sampling the hair root point cloud according to the sampling control information, to obtain sampling points; and
determining virtual hairs corresponding to the sampling points as simulated virtual hairs, and determining virtual hairs corresponding to hair root points other than the sampling points in the hair root point cloud as interpolated virtual hairs,
simulating the simulated virtual hairs using a physical simulation policy, and moving the interpolated virtual hairs based on the simulated virtual hairs.

20. The system of claim 19,
wherein the sampling the hair root point cloud comprises:
generating a voxel grid set according to the sampling control information and location range information of the hair root point cloud, the sampling control information being configured for determining a size of each voxel grid in the voxel grid set, and the location range information of the hair root point cloud being configured for determining a coverage range of the voxel grid set;
establishing a mapping between the hair root point cloud and the voxel grid set, the mapping being configured for indicating a belonging relationship between a hair root point in the hair root point cloud and a voxel grid in the voxel grid set; and
determining, in each voxel grid according to the mapping, a hair root point belonging to the voxel grid, and sampling, according to the sampling control information, the hair root point belonging to the voxel grid, to obtain a sampling point in the voxel grid, and
wherein voxel grids in the voxel grid set are sequentially sampled in a sampling order; and the determining, in each voxel grid according to the mapping, a hair root point belonging to the voxel grid, and sampling, according to the sampling control information, the hair root point belonging to the voxel grid, to obtain a sampling point in the voxel grid comprises:
determining, according to the mapping when a sampling voxel grid is a current voxel grid, a hair root point belonging to the current voxel grid, and randomly sampling, according to the sampling control information, the hair root point belonging to the current voxel grid;
determining, when a distance between a randomly sampled hair root point and an existing sampling point is greater than the sampling control information, the randomly sampled hair root point as a new sampling point; and
determining, according to the mapping when a quantity of times of random sampling on the current voxel grid reaches a sampling quantity threshold, a hair root point belonging to a next voxel grid of the current voxel grid, and randomly sampling, according to the sampling control information, the hair root point belonging to the next voxel grid until all the voxel grids in the voxel grid set are traversed.
